(19) United States
(12) Patent Application Publication
(10) Pub. No.: US 2025/0220419 A1
(43) Pub. Date: Jul. 3, 2025

(54) PHYSICAL LAYER (PHY) SECURITY FOR PASSIVE INTERNET OF THINGS (IOT) DEVICES

(71) Applicant: QUALCOMM INCORPORATED, San Diego, CA (US)

(72) Inventors: Ahmed Elshafie, San Diego, CA (US); Yuchul Kim, San Diego, CA (US); Zhikun Wu, Beijing (CN); Hung Dinh Ly, San Diego, CA (US); Alexandros Manolakos, Athens (GR); Linhai He, San Diego, CA (US); Huilin Xu, Temecula, CA (US)

(21) Appl. No.: 18/851,661

(22) PCT Filed: May 26, 2022
(86) PCT No.: PCT/CN2022/095167

§ 371 Date: Sep. 26, 2024

(51) Int. Cl. H04W 12/0471; H04L 5/00; H04W 12/041; H04W 24/08

(52) U.S. Cl. CPC H04W 12/0471; H04L 5/0048; H04W 12/041; H04W 24/08

(57) ABSTRACT

This disclosure provides systems, methods and apparatus, including computer programs encoded on computer storage media, for physical layer security for passive Internet of Things (IoT) devices. In some aspects, a source device and a reader device may communicate via a passive wireless device, such as an IoT tag, which may reflect or backscatter signaling from the source device to the reader device. The source device, the reader device, and the passive wireless device may secure communication in a physical layer (PHY) in accordance with one or more PHY security keys. As such, the source device may transmit a first message to the passive wireless device in accordance with a first PHY security key and the passive wireless device may transmit a second message to the reader device in accordance with a second PHY security key to secure communication to and from the passive wireless device.

### CROSS REFERENCE

The present Application is a 371 national stage filing of International PCT Application No. PCT/CN2022/095167 by Elshafie et al. entitled “PHYSICAL LAYER (PHY) SECURITY FOR PASSIVE INTERNET OF THINGS (IoT) DEVICES,” filed May 26, 2022, which is assigned to the assignee hereof, and which is expressly incorporated by reference in its entirety herein.

### TECHNICAL FIELD

This disclosure relates to wireless communications, including physical layer (PHY) security for passive internet of things (IoT) devices.

### DESCRIPTION OF THE RELATED TECHNOLOGY

Wireless communications systems are widely deployed to provide various types of communication content such as voice, video, packet data, messaging, broadcast, and so on. These systems may be capable of supporting communication with multiple users by sharing the available system resources (such as time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations (BSs) or one or more network access nodes, each simultaneously supporting communication for multiple communication devices, which may be otherwise known as user equipment (UE).

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for wireless communications at a passive wireless device. The method may include receiving a first message in accordance with a first physical layer (PHY) security key that secures communication between a source device and the passive wireless device and transmitting a second message via a backscattering of the first message and in accordance with a second PHY security key that secures communication between the passive wireless device and a reader device.

Another innovative aspect of the subject matter described in this disclosure can be implemented in an apparatus for wireless communications at a passive wireless device. The apparatus may include an interface and a processing system. The interface may be configured to obtain a first message in accordance with a first PHY security key that secures communication between a source device and the passive wireless device and output a second message via a backscattering of the first message and in accordance with a second PHY security key that secures communication between the passive wireless device and a reader device.

Another innovative aspect of the subject matter described in this disclosure can be implemented in an apparatus for wireless communications at a passive wireless device. The apparatus may include a processor, memory coupled with the processor, and instructions stored in the memory. The instructions may be executable by the processor to cause the apparatus to receive a first message in accordance with a first PHY security key that secures communication between a source device and the passive wireless device and transmit a second message via a backscattering of the first message and in accordance with a second PHY security key that secures communication between the passive wireless device and a reader device.

Another innovative aspect of the subject matter described in this disclosure can be implemented in another apparatus for wireless communications at a passive wireless device. The apparatus may include means for receiving a first message in accordance with a first PHY security key that secures communication between a source device and the passive wireless device and means for transmitting a second message via a backscattering of the first message and in accordance with a second PHY security key that secures communication between the passive wireless device and a reader device.

Another innovative aspect of the subject matter described in this disclosure can be implemented in a non-transitory computer-readable medium storing code for wireless communications at a passive wireless device. The code may include instructions executable by a processor to receive a first message in accordance with a first PHY security key that secures communication between a source device and the passive wireless device and transmit a second message via a backscattering of the first message and in accordance with a second PHY security key that secures communication between the passive wireless device and a reader device.

One innovative aspect of the subject matter described in this disclosure can be implemented in a method for wireless communications at a reader device. The method may include receiving a first message from a source device via a passive wireless device, the passive wireless device associated with a backscattering of the first message and decrypting the first message in accordance with a PHY security key that secures communication between the passive wireless device and the reader device.

Another innovative aspect of the subject matter described in this disclosure can be implemented in an apparatus for wireless communications at a reader device. The apparatus may include an interface and a processing system. The interface may be configured to obtain a first message from a source device via a passive wireless device, the passive wireless device associated with a backscattering of the first message. The processing system may be configured to decrypt the first message in accordance with a PHY security key that secures communication between the passive wireless device and the reader device.

Another innovative aspect of the subject matter described in this disclosure can be implemented in an apparatus for wireless communications at a reader device. The apparatus may include a processor, memory coupled with the processor, and instructions stored in the memory. The instructions may be executable by the processor to cause the apparatus to receive a first message from a source device via a passive wireless device, the passive wireless device associated with a backscattering of the first message and decrypt the first message in accordance with a PHY security key that secures communication between the passive wireless device and the reader device.

Another innovative aspect of the subject matter described in this disclosure can be implemented in another apparatus for wireless communications at a reader device. The apparatus may include means for receiving a first message from a source device via a passive wireless device, the passive wireless device associated with a backscattering of the first message and means for decrypting the first message in accordance with a PHY security key that secures communication between the passive wireless device and the reader device.

Another innovative aspect of the subject matter described in this disclosure can be implemented in a non-transitory computer-readable medium storing code for wireless communications at a reader device. The code may include instructions executable by a processor to receive a first message from a source device via a passive wireless device, the passive wireless device associated with a backscattering of the first message and decrypt the first message in accordance with a PHY security key that secures communication between the passive wireless device and the reader device.

One innovative aspect of the subject matter described in this disclosure can be implemented in a method for wireless communications at a source device. The method may include encrypting a first message in accordance with a PHY security key that secures communication between the source device and a passive wireless device and transmitting the first message to a reader device via the passive wireless device, the passive wireless device associated with a backscattering of the first message.

Another innovative aspect of the subject matter described in this disclosure can be implemented in an apparatus for wireless communications at a source device. The apparatus may include an interface and a processing system. The processing system may be configured to encrypt a first message in accordance with a PHY security key that secures communication between the source device and a passive wireless device. The interface may be configured to output the first message to a reader device via the passive wireless device, the passive wireless device associated with a backscattering of the first message.

Another innovative aspect of the subject matter described in this disclosure can be implemented in an apparatus for wireless communications at a source device. The apparatus may include a processor, memory coupled with the processor, and instructions stored in the memory. The instructions may be executable by the processor to cause the apparatus to encrypt a first message in accordance with a PHY security key that secures communication between the source device and a passive wireless device and transmit the first message to a reader device via the passive wireless device, the passive wireless device associated with a backscattering of the first message.

Another innovative aspect of the subject matter described in this disclosure can be implemented in another apparatus for wireless communications at a source device. The apparatus may include means for encrypting a first message in accordance with a PHY security key that secures communication between the source device and a passive wireless device and means for transmitting the first message to a reader device via the passive wireless device, the passive wireless device associated with a backscattering of the first message.

Another innovative aspect of the subject matter described in this disclosure can be implemented in a non-transitory computer-readable medium storing code for wireless communications at a source device. The code may include instructions executable by a processor to encrypt a first message in accordance with a PHY security key that secures communication between the source device and a passive wireless device and transmit the first message to a reader device via the passive wireless device, the passive wireless device associated with a backscattering of the first message.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows an example wireless communications system that supports physical layer (PHY) security for passive internet of things (IoT) devices.

FIG. 2 shows an example network architecture that supports PHY security for passive IoT devices.

FIG. 3 shows an example signaling diagram that supports PHY security for passive IoT devices.

FIG. 4 shows an example key selection diagram that supports PHY security for passive IoT devices.

FIGS. 5 and 6 show example communication timelines that support PHY security for passive IoT devices.

FIG. 7 shows an example process flow that supports PHY security for passive IoT devices.

FIGS. 8 and 9 show block diagrams of example devices that support PHY security for passive IoT devices.

FIGS. 10-12 show flowcharts illustrating example methods that support PHY security for passive IoT devices.

Like reference numbers and designations in the various drawings indicate like elements.

### DETAILED DESCRIPTION

The following description is directed to some implementations for the purposes of describing the innovative aspects of this disclosure. However, a person having ordinary skill in the art will readily recognize that the teachings herein can be applied in a multitude of different ways. The described implementations may be implemented in any device, system or network that is capable of transmitting and receiving radio frequency (RF) signals according to any of the Institute of Electrical and Electronics Engineers (IEEE) 16.11 standards, or any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or IoT network, such as a system utilizing third generation (3G), fourth generation (4G) or fifth generation (5G), or further implementations thereof, technology.

In some wireless communications systems, a source device may transmit signaling to a reader device via a passive wireless device, which may be referred to or understood as a reflective device or a backscatter device. A wireless tag in an internet of things (IoT) deployment may be an example of such a passive wireless device. The passive wireless device may modulate information on the signaling received from the source device such that the reader device receives information from both the source device and the passive wireless device. For example, the passive wireless device may modulate information with the signaling from the source device in accordance with turning reflection ON to transmit or convey a first bit (such as a “1” bit) and in accordance with switching reflection OFF to transmit or convey a second bit (such as a “0” bit). In some systems, communication between the source device and the passive wireless device and between the passive wireless device and the reader device may be unsecured, which may allow a malicious device to intercept messaging to or from the passive wireless device.

In some implementations, a source device, a reader device, and a passive wireless device may support one or more configuration- or signaling-based mechanisms according to which the devices may achieve physical layer (PHY) security for communication to and from the passive wireless device. For example, the source device may modulate or otherwise modify a first message with a first PHY security key and may transmit the secured first message to the passive wireless device. The passive wireless device, which may receive an indication of the first PHY security key prior to receiving the first message or otherwise store the first PHY security key, may remove the first PHY security key from the first message. The passive wireless device may modulate or otherwise modify a second message with a second PHY security key and transmit the second message to the reader device via a reflection or backscatter technique. Further, the source device and the reader device may support a third PHY security key that secures communication between the source device and the reader device and the source device, the reader device, and the passive wireless device may support various mechanisms or procedures for selecting, receiving, identifying, ascertaining, obtaining, or otherwise determining which one or more PHY security keys are to be used to secure communication between the devices.

Particular implementations of the subject matter described in this disclosure can be implemented to realize one or more of the following potential advantages. For example, in accordance with using PHY security keys to secure communication between a source device, a reader device, and a passive wireless device, the devices may achieve greater system security. Systems (such as IoT systems) involving the use of one or more passive wireless devices may likewise achieve or experience greater system-level security and increased resilience to or protection from an attack or data theft, which may facilitate the deployment of such systems (as such systems satisfy more robust security constraints or guarantees). In other words, implementations of the subject matter described in this disclosure may maintain privacy and security of communications performed by or through a passive wireless device (such as an RFID tag) and, accordingly, remedy security concerns associated with systems that deploy passive wireless devices and facilitate greater adoption of passive wireless devices, which may increase data rates and system capacity across various networks. For example, systems involving secured passive wireless devices may provide relatively higher data rates, greater capacity, or otherwise perform enhanced operations as compared to systems without secured passive wireless devices.

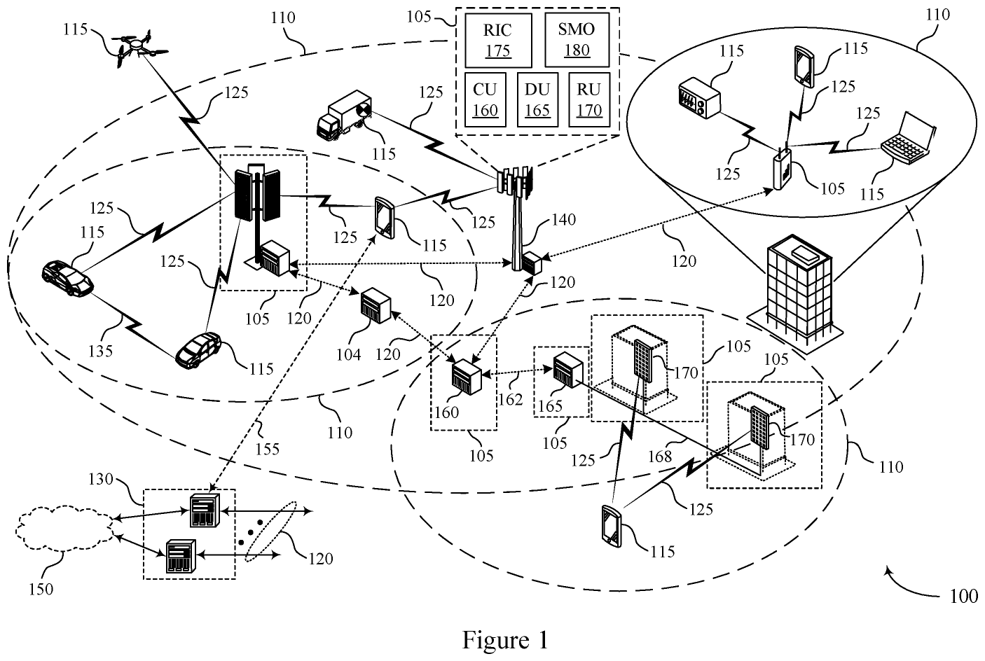

FIG. 1 shows an example wireless communications system 100 that supports PHY security for passive IoT devices. The wireless communications system 100 may include one or more network entities 105, one or more UEs 115, and a core network 130. In some implementations, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some implementations, network entities 105 and UEs 115 may wirelessly communicate via one or more communication links 125 (such as a radio frequency (RF) access link). For example, a network entity 105 may support a coverage area 110 (such as a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (such as any network entity described herein), a UE 115 (such as any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some implementations, network entities 105 may communicate with the core network 130, or with one another, or both. For example, network entities 105 may communicate with the core network 130 via one or more backhaul communication links 120 (such as in accordance with an S1, N2, N3, or other interface protocol). In some implementations, network entities 105 may communicate with one another over a backhaul communication link 120 (such as in accordance with an X2, Xn, or other interface protocol) either directly (such as directly between network entities 105) or indirectly (such as via a core network 130). In some implementations, network entities 105 may communicate with one another via a midhaul communication link 162 (such as in accordance with a midhaul interface protocol) or a fronthaul communication link 168 (such as in accordance with a fronthaul interface protocol), or any combination thereof. The backhaul communication links 120, midhaul communication links 162, or fronthaul communication links 168 may be or include one or more wired links (such as an electrical link, an optical fiber link), one or more wireless links (such as a radio link, a wireless optical link), among other examples or various combinations thereof. A UE 115 may communicate with the core network 130 through a communication link 155.

One or more of the network entities 105 described herein may include or may be referred to as a base station (BS) 140 (such as a base transceiver station, a radio BS, an NR BS, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some implementations, a network entity 105 (such as a BS 140) may be implemented in an aggregated (such as monolithic, standalone) BS architecture, which may be configured to utilize a protocol stack that is physically or logically integrated within a single network entity 105 (such as a single RAN node, such as a BS 140).

In some implementations, a network entity 105 may be implemented in a disaggregated architecture (such as a disaggregated BS architecture, a disaggregated RAN architecture), which may be configured to utilize a protocol stack that is physically or logically distributed among two or more network entities 105, such as an integrated access backhaul (IAB) network, an open RAN (O-RAN) (such as a network configuration sponsored by the O-RAN Alliance), or a virtualized RAN (vRAN) (such as a cloud RAN (C-RAN)). For example, a network entity 105 may include one or more of a central unit (CU) 160, a distributed unit (DU) 165, a radio unit (RU) 170, a RAN Intelligent Controller (RIC) 175 (such as a Near-Real Time RIC (Near-RT RIC), a Non-Real Time RIC (Non-RT RIC)), a Service Management and Orchestration (SMO) 180 system, or any combination thereof. An RU 170 also may be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (such as separate physical locations). In some implementations, one or more network entities 105 of a disaggregated RAN architecture may be implemented as virtual units (such as a virtual CU (VCU), a virtual DU (VDU), a virtual RU (VRU)).

The split of functionality between a CU 160, a DU 165, and an RU 170 is flexible and may support different functionalities depending upon which functions (such as network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some implementations, the CU 160 may host upper protocol layer (such as layer 3 (L3), layer 2 (L2)) functionality and signaling (such as Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (such as PHY) or L2 (such as radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (such as via one or more RUs 170). In some implementations, a functional split between a CU 160 and a DU 165, or between a DU 165 and an RU 170 may be within a protocol layer (such as some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (such as F1, F1-c, F1-u), and a DU 165 may be connected to one or more RUs 170 via a fronthaul communication link 168 (such as open fronthaul (FH) interface). In some implementations, a midhaul communication link 162 or a fronthaul communication link 168 may be implemented in accordance with an interface (such as a channel) between layers of a protocol stack supported by respective network entities 105 that are in communication over such communication links.

In wireless communications systems (such as wireless communications system 100), infrastructure and spectral resources for radio access may support wireless backhaul link capabilities to supplement wired backhaul connections, providing an IAB network architecture (such as to a core network 130). In some implementations, in an IAB network, one or more network entities 105 (such as IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (such as a donor BS 140). The one or more donor network entities 105 (such as IAB donors) may be in communication with one or more additional network entities 105 (such as IAB nodes 104) via supported access and backhaul links (such as backhaul communication links 120). IAB nodes 104 may include an IAB mobile termination (IAB-MT) controlled (such as scheduled) by DUs 165 of a coupled IAB donor. An IAB-MT may include an independent set of antennas for relay of communications with UEs 115, or may share the same antennas (such as of an RU 170) of an IAB node 104 used for access via the DU 165 of the IAB node 104 (such as referred to as virtual IAB-MT (vIAB-MT)). In some implementations, the IAB nodes 104 may include DUs 165 that support communication links with additional entities (such as IAB nodes 104, UEs 115) within the relay chain or configuration of the access network (such as downstream). In such implementations, one or more components of the disaggregated RAN architecture (such as one or more IAB nodes 104 or components of IAB nodes 104) may be configured to operate according to the techniques described herein.

For instance, an access network (AN) or RAN may include communications between access nodes (such as an IAB donor), IAB nodes 104, and one or more UEs 115. The IAB donor may facilitate connection between the core network 130 and the AN (such as via a wired or wireless connection to the core network 130). That is, an IAB donor may refer to a RAN node with a wired or wireless connection to core network 130. The IAB donor may include a CU 160 and at least one DU 165 (such as and RU 170), in which implementation the CU 160 may communicate with the core network 130 over an interface (such as a backhaul link). IAB donor and IAB nodes 104 may communicate over an F1 interface according to a protocol that defines signaling messages (such as an F1 AP protocol). Additionally, or alternatively, the CU 160 may communicate with the core network over an interface, which may be an example of a portion of backhaul link, and may communicate with other CUs 160 (such as a CU 160 associated with an alternative IAB donor) over an Xn-C interface, which may be an example of a portion of a backhaul link.

An IAB node 104 may refer to a RAN node that provides IAB functionality (such as access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (such as an IAB donor may relay transmissions for UEs through one or more other IAB nodes 104). Additionally, or alternatively, an IAB node 104 also may be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (such as DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (such as a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (such as transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the implementation of the techniques described herein applied in the context of a disaggregated RAN architecture, one or more components of the disaggregated RAN architecture may be configured to support PHY security for passive IoT devices as described herein. For example, some operations described as being performed by a UE 115 or a network entity 105 (such as a BS 140) may additionally, or alternatively, be performed by one or more components of the disaggregated RAN architecture (such as IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” also may be referred to as a unit, a station, a terminal, or a client, among other examples. A UE 115 also may include or may be referred to as a personal electronic device such as a cellular phone, a personal digital assistant (PDA), a tablet computer, a laptop computer, or a personal computer. In some implementations, a UE 115 may include or be referred to as a wireless local loop (WLL) station, an IoT device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay BSs, among other examples, as shown in FIG. 1.

The UEs 115 and the network entities 105 may wirelessly communicate with one another via one or more communication links 125 (such as an access link) over one or more carriers. The term “carrier” may refer to a set of RF spectrum resources having a defined PHY structure for supporting the communication links 125. For example, a carrier used for a communication link 125 may include a portion of a RF spectrum band (such as a bandwidth part (BWP)) that is operated according to one or more PHY channels for a given radio access technology (such as LTE, LTE-A, LTE-A Pro, NR). Each PHY channel may carry acquisition signaling (such as synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (such as entity, sub-entity) of a network entity 105. For example, the terms “transmitting,” “receiving,” or “communicating,” when referring to a network entity 105, may refer to any portion of a network entity 105 (such as a BS 140, a CU 160, a DU 165, a RU 170) of a RAN communicating with another device (such as directly or via one or more other network entities 105).

Signal waveforms transmitted over a carrier may be made up of multiple subcarriers (such as using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (such as a duration of one modulation symbol) and one subcarrier, in which implementation the symbol period and subcarrier spacing may be inversely related. The quantity of bits carried by each resource element may depend on the modulation scheme (such as the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (such as a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (such as 10 milliseconds (ms)). Each radio frame may be identified by a system frame number (SFN) (such as ranging from 0 to 1023).

Each frame may include multiple consecutively numbered subframes or slots, and each subframe or slot may have the same duration. In some implementations, a frame may be divided (such as in the time domain) into subframes, and each subframe may be further divided into a quantity of slots. Alternatively, each frame may include a variable quantity of slots, and the quantity of slots may depend on subcarrier spacing. Each slot may include a quantity of symbol periods (such as depending on the length of the cyclic prefix prepended to each symbol period). In some wireless communications systems 100, a slot may further be divided into multiple mini-slots containing one or more symbols. Excluding the cyclic prefix, each symbol period may contain one or more (such as N_{f}) sampling periods. The duration of a symbol period may depend on the subcarrier spacing or frequency band of operation.

A subframe, a slot, a mini-slot, or a symbol may be the smallest scheduling unit (such as in the time domain) of the wireless communications system 100 and may be referred to as a transmission time interval (TTI). In some implementations, the TTI duration (such as a quantity of symbol periods in a TTI) may be variable. Additionally, or alternatively, the smallest scheduling unit of the wireless communications system 100 may be dynamically selected (such as in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (such as a control resource set (CORESET)) for a physical control channel may be defined by a set of symbol periods and may extend across the system bandwidth or a subset of the system bandwidth of the carrier. One or more control regions (such as CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (such as control channel elements (CCEs)) associated with encoded information for a control information format having a given payload size. Search space sets may include common search space sets configured for sending control information to multiple UEs 115 and UE-specific search space sets for sending control information to a specific UE 115.

In some implementations, a network entity 105 (such as a BS 140, an RU 170) may be movable and therefore provide communication coverage for a moving coverage area 110. In some implementations, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (such as via Machine-to-Machine (M2M) communication). M2M communication or MTC may refer to data communication technologies that allow devices to communicate with one another or a network entity 105 (such as a BS 140) without human intervention. In some implementations, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some implementations, a UE 115 may be able to communicate directly with other UEs 115 over a device-to-device (D2D) communication link 135 (such as in accordance with a peer-to-peer (P2P), D2D, or sidelink protocol). In some implementations, one or more UEs 115 of a group that are performing D2D communications may be within the coverage area 110 of a network entity 105 (such as a BS 140, an RU 170), which may support aspects of such D2D communications being configured by or scheduled by the network entity 105. In some implementations, one or more UEs 115 in such a group may be outside the coverage area 110 of a network entity 105 or may be otherwise unable to or not configured to receive transmissions from a network entity 105. In some implementations, groups of the UEs 115 communicating via D2D communications may support a one-to-many (1:M) system in which each UE 115 transmits to each of the other UEs 115 in the group. In some implementations, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (such as UEs 115). In some implementations, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some implementations, vehicles in a V2X system may communicate with roadside infrastructure, such as roadside units, or with the network via one or more network nodes (such as network entities 105, BSs 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (such as a mobility management entity (MME), an access and mobility management function (AMF)) and at least one user plane entity that routes packets or interconnects to external networks (such as a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (such as BSs 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (such as less than 100 kilometers) compared to transmission using the smaller frequencies and longer waves of the high frequency (HF) or very high frequency (VHF) portion of the spectrum below 300 MHz.

The wireless communications system 100 also may operate in a super high frequency (SHF) region using frequency bands from 3 GHz to 30 GHZ, also known as the centimeter band, or in an extremely high frequency (EHF) region of the spectrum (such as from 30 GHz to 300 GHz), also known as the millimeter band. In some implementations, the wireless communications system 100 may support millimeter wave (mmW) communications between the UEs 115 and the network entities 105 (such as BSs 140, RUs 170), and EHF antennas of the respective devices may be smaller and more closely spaced than UHF antennas. In some implementations, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some implementations, operations in unlicensed bands may be associated with a carrier aggregation configuration in conjunction with component carriers operating in a licensed band (such as LAA). Operations in unlicensed spectrum may include downlink transmissions, uplink transmissions, P2P transmissions, or D2D transmissions, among other examples.

A network entity 105 (such as a BS 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more BS antennas or antenna arrays may be co-located at an antenna assembly, such as an antenna tower. In some implementations, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

Beamforming, which also may be referred to as spatial filtering, directional transmission, or directional reception, is a signal processing technique that may be used at a transmitting device or a receiving device (such as a network entity 105, a UE 115) to shape or steer an antenna beam (such as a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (such as with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer also may use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY, transport channels may be mapped to physical channels.

In some implementations, the various devices illustrated by and described with reference to FIG. 1 may support one or more configuration- or signaling-based mechanisms to secure communication involving a passive wireless device in the PHY. For example, a source device and a reader device, each of which may be an example of a UE 115 or a network entity 105, may communicate via a passive wireless device in accordance with the passive wireless device reflecting communication from the source device to the reader device. Further, the passive wireless device may convey additional information (such as information in addition to the information transmitted by the source device) to the reader device in accordance with a backscattering modulation technique. As described herein, information or signaling transmitted by the source device may be referred to or understood as a first message and information or signaling conveyed by the passive wireless device may be referred to or understood as a second message.

As such, in accordance with example implementations described herein, the source device may encrypt the first message in accordance with a first PHY security key and transmit the encrypted first message to the passive wireless device. The passive wireless device may receive the encrypted first message, decrypt the first message in accordance with the first PHY security key, encrypt the second message in accordance with a second PHY security key, and transmit the encrypted second message. The reader device may decrypt the second message in accordance with the second PHY security key to obtain the information signaled from the source device and the passive wireless device.

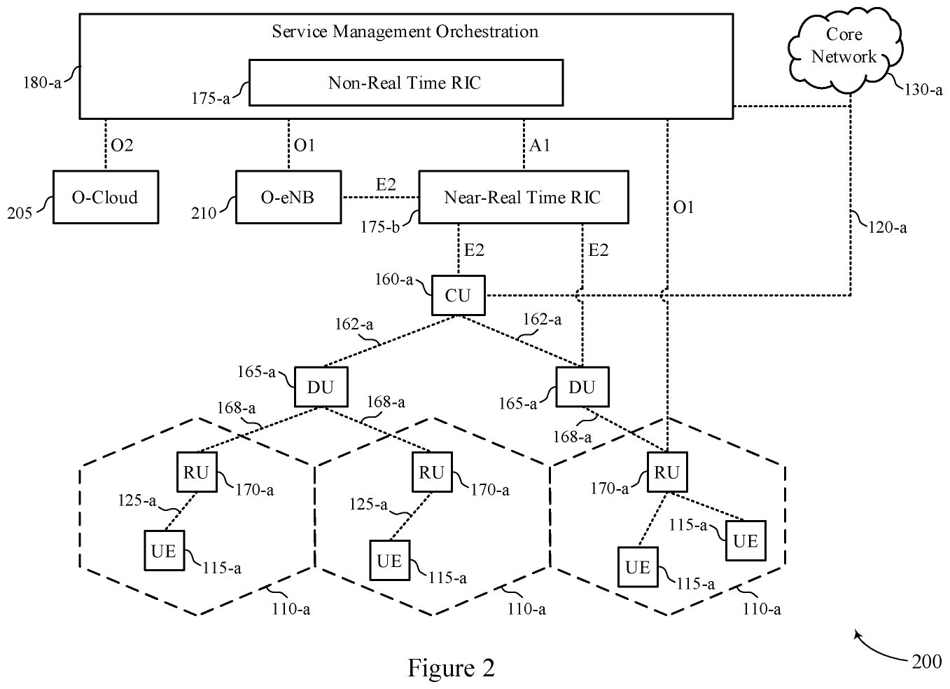

FIG. 2 shows an example network architecture 200 (such as a disaggregated base station architecture, a disaggregated RAN architecture) that supports PHY security for passive IoT devices. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (such as a Near-RT RIC 175-b via an E2 link, or a Non-RT RIC 175-a associated with an SMO 180-a (such as an SMO Framework), or both). A CU 160-a may communicate with one or more DUs 165-a via respective midhaul communication links 162-a (such as an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (such as CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (such as data, information) via a wired or wireless transmission medium. Each network entity 105, or an associated processor (such as controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (such as an RF transceiver) configured to receive or transmit signals, or both, over a wireless transmission medium to one or more of the other network entities 105.

In some implementations, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (such as CU-UP), control plane functionality (such as CU-CP), or a combination thereof. In some implementations, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (such as base station functions, RAN functions) to control the operation of one or more RUs 170-a. In some implementations, a DU 165-a may host, at least partially, one or more of an RLC layer, a MAC layer, and one or more aspects of a PHY (such as a high PHY, such as modules for FEC encoding and decoding, scrambling, modulation and demodulation, or the like) depending, at least in part, on a functional split, such as those defined by the 3rd Generation Partnership Project (3GPP). In some implementations, a DU 165-a may further host one or more low PHYs. Each layer may be implemented with an interface configured to communicate signals with other layers hosted by the DU 165-a, or with control functions hosted by a CU 160-a.

In some implementations, lower-layer functionality may be implemented by one or more RUs 170-a. For example, an RU 170-a, controlled by a DU 165-a, may correspond to a logical node that hosts RF processing functions, or low-PHY functions (such as performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some implementations, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (such as an O1 interface). For virtualized network entities 105, the SMO 180-a may be configured to interact with a cloud computing platform (such as an O-Cloud 205) to perform network entity life cycle management (such as to instantiate virtualized network entities 105) via a cloud computing platform interface (such as an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (such as via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (such as via an A1 interface) the Near-RT RIC 175-b. The Near-RT RIC 175-b may be configured to include a logical function that enables near-real-time control and optimization of RAN elements and resources via data collection and actions over an interface (such as via an E2 interface) connecting one or more CUs 160-a, one or more DUs 165-a, or both, as well as an O-eNB 210, with the Near-RT RIC 175-b.

In some implementations, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some implementations, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (such as reconfiguration via 01) or via generation of RAN management policies (such as A1 policies).

In some implementations, one or more devices, entities, or functionalities associated with the network architecture 200 may support one or more configuration- or signaling-based mechanisms to secure communication involving a passive wireless device in the PHY. For example, a source device and a reader device, each of which may be an example of a UE 115 or a network entity 105, may communicate via a passive wireless device in accordance with the passive wireless device reflecting communication from the source device to the reader device. In some aspects, such a passive wireless device may be an example of a UE 115 (with reduced capability (RedCap) or non-RedCap) deploying a radio frequency identification (RFID) tag module or radio, and the UE 115 may use the RFID tag module or radio if in a power saving state (such as if a battery power of the UE 115 falls below a threshold battery power) or if performing low power communications (such as transmitting using a transmit power that is less than a threshold transmit power). In other words, a UE 115 may be an RFID device, a device that uses a low complexity receiver, or a device that is equipped with an RFID tag radio and any of such devices may be examples of a passive wireless device. The passive wireless device may convey additional information (such as information in addition to the information transmitted by the source device) to the reader device in accordance with a backscattering modulation technique.

As described herein, information or signaling transmitted by the source device may be referred to or understood as a first message and information or signaling conveyed by the passive wireless device may be referred to or understood as a second message. The first message may be associated with (such as conveyed via) a signal x(n) and the second message may be associated with (such as conveyed via) a signal s(n)x(n). Accordingly, in some implementations, the source device may encrypt the first message in accordance with modulating or otherwise modifying x(n) with a first PHY security key SK₁(n). The passive wireless device may receive the encrypted SK₁(n)x(n) and transmit a backscattered signal to the reader device in accordance with a second PHY security key SK₂(n). For example, the passive wireless device may reflect, relay, or transmit a signal SK₂(n)s(n)x(n) to the reader device. The reader device may accordingly decrypt the signaling in accordance with the second PHY security key SK₂(n) and obtain the information associated with or conveyed by s(n) and x(n). As such, the source device, the reader device, and the passive wireless device may exchange signaling in a secured manner.

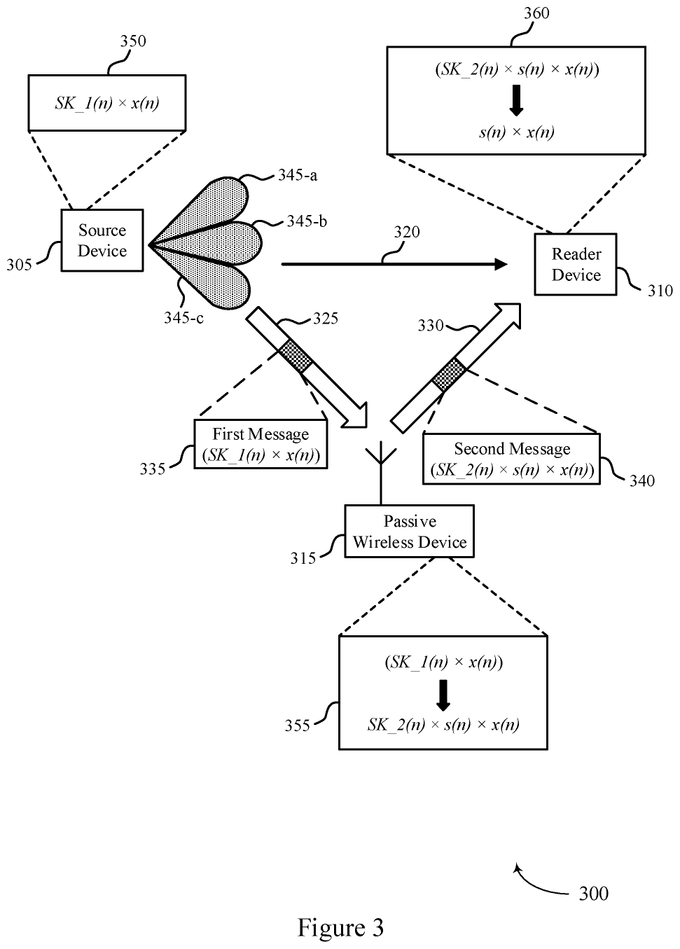

FIG. 3 shows an example signaling diagram 300 that supports PHY security for passive IoT devices. The signaling diagram 300 may implement or be implemented to realize aspects of the wireless communications system 100 or the network architecture 200. For example, the signaling diagram 300 illustrates communication between a source device 305 (such as a radio frequency source device), a reader device 310, and a passive wireless device 315 (which may be an example of a tag, such as an IoT tag). In some implementations, the source device 305, the reader device 310, and the passive wireless device 315 may use one or more PHY security keys to secure communication between the devices in the PHY.

In some aspects, the passive wireless device 315 may be an example of a passive IoT device and may employ energy harvesting and backscatter communication to communicate with one or both of the source device 305 and the reader device 310. For example, the passive wireless device 315 may support energy harvesting enabled communication services (EHECS) in a 5G system (5GS) and, as such, may be a battery-less device or a device that otherwise has limited energy storage (such as a capacitor). The passive wireless device 315 may be a low tier device, such as a device tier similar to an RFID device, a RedCap device, or an enhanced RedCap (eRedCap) device.

Alternatively, the passive wireless device 315 may not be a RedCap device and the described techniques may be applicable to non-RedCap implementations. For example, the passive wireless device 315 may be an example of a cell phone, a laptop, a smart watch, smart jewelry, a robot, a manufacturing component, a vehicle, an IoT tag, an antenna panel, a repeater, one or more patch antennas, a reflective intelligent surface (RIS), an IoT device, a narrowband (NB)-IoT device, an RFID device, a UE 115 (such as a UE 115 equipped with an RFID tag module or radio), a low complexity receiver, or an industrial IoT device (IIoT), among other examples of devices that are associated with IoT applications or capable of relaying or reflecting communication between the source device 305 and the reader device 310. In addition, or as an alternative to backscatter communication-based passive IoT where a battery-less device may collect energy from ambient radio frequency signaling and use the collected energy to redirect the signaling (such as an RFID tag), the passive wireless device 315 may use energy harvesting to power components of the passive wireless device 315 (such as an analog-to-digital converter (ADC), a mixer, or one or more oscillators).

The passive wireless device 315 may support identification, tracking, power sourcing, access control or connectivity managing, or positioning implementations, among other examples. The passive wireless device, in some 5G deployment scenarios, may support or be associated with one or more constraints for data rates, power consumption, and density and may support one or more procedures or techniques associated with on-boarding (such as connection establishment), provisioning (such as connection management), and decommissioning (such as connection de-establishment) of the passive wireless device. Further, the passive wireless device 315 may support one or more procedures or techniques associated with identification, authentication and authorization, access control, mobility management, security, and other communication mechanisms.

In examples in which the passive wireless device 315 supports energy harvesting, the passive wireless device 315 may opportunistically harvest energy in an environment to charge a battery or otherwise obtain power to perform one or more operations (such as decoding, decryption, encryption, encoding, signal generation, or transmission). For example, the passive wireless device 315 may harvest or otherwise obtain energy from solar, heat, or ambient radio frequency radiation, or any combination thereof, and store the harvested energy in a rechargeable battery. In some aspects, the passive wireless device 315 may support energy harvesting techniques to support operation on intermittently available energy harvested from the environment as variations in amount of harvested energy can be expected. For example, the passive wireless device 315 (such as an NB-IoT device or an RFID device) may use energy harvested from solar to support one or more operations. Further, variations in amount of traffic (such as data or communication traffic) can be expected. As such, the passive wireless device 315, if operating on intermittently available energy harvested from the environment, may not (or at least may not be expected to) sustain relatively long continuous reception or transmission.

The passive wireless device 315 may reflect, relay, or backscatter communication from the source device 305 to the reader device 310 and, in some aspects, may convey additional information to the reader device 310 (information in addition to that conveyed by the source device 305) via the reflected, relayed, or backscattered signal. For example, the passive wireless device 315 may receive a signal from the source device 305 and may modulate additional information onto the signal in accordance with an information modulation method. In some implementations, the information modulation method employed by the passive wireless device 315 (a backscatter device) may be amplitude shift keying (ASK), according to which the passive wireless device 315 may switch on reflection when transmitting an information bit “1” and may switch off the reflection when transmitting an information bit “0.”

For example, the source device 305 may transmit a radio wave denoted as x(n) and the passive wireless device 315 may convey information bits of s(n)∈{0,1}. As such, a received signal at the reader device 310 may be defined by Equation 1, shown below.

$$y ( n ) = ( {h}_{D 1 D 2} ( n ) + {σ}_{f} {h}_{D 1 T} ( n ) {h}_{TD 2} ( n ) s ( n ) ) x ( n ) + noise \qquad ( 1 )$$

As shown above in Equation 1, h_{D1D2}(n) may denote a channel 320 between the source device 305 and the reader device 310, of may denote a reflection coefficient of the passive wireless device 315, h_{D1T}(n) may denote a channel 325 between the source device 305 and the passive wireless device 315, h_{TD2}(n) may denote a channel 330 between the passive wireless device 315 and the reader device 310, and noise may denote any channel noise that impacts the signaling from the source device 305 to the reader device 310. Accordingly, if s(n)=0, reflection may be switched off at the passive wireless device 315 and the reader device 310 may receive the direct link signal from the source device 305 (and may not receive any reflected signal from the passive wireless device 315). In such scenarios in which s(n)=0, y (n)=h_{D1D2}(n)×(n)+noise. Further, if s(n)=1, reflection may be switched on at the passive wireless device 315 and the reader device 310 may receive a superposition of both the direct link signal and the backscatter link signal, as shown in Equation 1.

In some wireless communications systems, secure communications may be crucial for successful and practical application of wireless communications. Further, IoT deployments may make security more crucial, as many devices may be connected to each other. In some systems, however, passive IoT communications may lack security outside of start and end commands that are sent using a password that is dedicated for or specific to the passive wireless device 315 (a tag). Such a password may be preconfigured at the wireless device 315, loaded (such as in hardware or software) at the passive wireless device 315, or configured or reconfigured at the passive wireless device 315 via L1, L2, or L3 signaling. For example, passive IoT tags may only perform envelop detection to detect data (such as commands from the source device 305, which may be a gNB or other network entity 105 or network unit), and tag communication may otherwise be unsecured in any layer. As such, signaling outside of the start and end commands may lack security, which may make the signaling vulnerable to sniffing, theft, interception, or other attacks from an attacking device.

Accordingly, in some implementations, the source device 305, the reader device 310, and the passive wireless device 315 may support security and authentication mechanisms to secure communication to and from the passive wireless device 315. For example, the source device 305, the reader device 310, and the passive wireless device 315 may support PHY security that is specifically associated with deployments involving the passive wireless device 315 (such as specifically associated with passive IoT devices and deployments). In some implementations, the passive wireless device 315 may store or be configured (such as via signaling from one or both of the source device 305 and the reader device 310) with one or more security keys to be used for securing the communications between the passive wireless device 315 and one or both of the source device 305 and the reader device 310 (such as for securing the backscattered signal s(n) or for securing reading commands).

In some aspects, the source device 305, the reader device 310, and the passive wireless device 315 may achieve PHY security in accordance with a first PHY security key SK₁(n) that secures communication between the source device 305 and the passive wireless device 315 and a second PHY security key SK₂(n) that secures communication between the passive wireless device 315 and the reader device 310. For example, the source device 305 may perform encryption 350 to encrypt a signal x(n) (a command to be sent to the passive wireless device 315) with the first PHY security key SK₁(n). To encrypt the signal x(n) with the first PHY security key SK₁(n), the source device 305 may modulate x(n) with SK₁(n) or may otherwise modify x(n) in accordance with SK₁(n). As described herein, the encryption 350 may include one or more of an encrypting operation and an encoding operation. For example, the source device 305 may achieve security for the signal x(n) in accordance with XORing data bits with SK₁(n) or in accordance with a multiplication of x(n) and SK₁(n). As illustrated by the example encryption 350, the source device 305 may multiply x(n) and SK₁(n) to obtain a secured first message 335. As such, the first message 335 may be conveyed via a signal SK₁(n)x(n). The source device 305 may transmit the first message 335 using one or more of a directional beam 345-a, a directional beam 345-b, and a directional beam 345-c.

The passive wireless device 315 may receive the first message 335 in accordance with the first PHY security key SK₁(n) and may perform decryption and encryption 355 to remove SK₁(n) from x(n) (such as to decrypt or decode x(n)) and to encrypt or encode a backscatter signal s(n) (a backscatter signal from the passive wireless device 315 to the reader device 310) in accordance with the second PHY security key SK₂(n). To decrypt or decode x(n) from SK₁(n), the passive wireless device 315 may perform a reverse of the operation used by the source device 305 to encrypt x(n). To encrypt or encode the backscatter signal s(n) with the second PHY security key SK₂(n), the passive wireless device 315 may modulate s(n) with SK₂(n) or may otherwise modify s(n) in accordance with SK₂(n). As described herein, the decryption and encryption 355 may include one or more of a decrypting operation, a decoding operation, an encrypting operation, and an encoding operation. For example, the passive wireless device 315 may achieve security for the signal s(n) in accordance with XORing data bits with SK₂(n) or in accordance with a multiplication of s(n) and SK₂(n). As illustrated by the example decryption and encryption 355, the passive wireless device 315 may multiply s(n) and SK₂(n) to obtain a secured second message 340. As such, the second message 340 may be conveyed via a signal SK₂(n)s(n)x(n).

Accordingly, considering channel conditions, the passive wireless device 315 may receive (via a command or writing to the passive wireless device 315) a signal y_{T}(n) and the reader device 310 may receive (via a reading from the passive wireless device 315) a signal y_{D2}(n), as defined in accordance with Equation 2 and Equation 3, respectively, as shown below. The reader device 310 may perform decryption 360 to decrypt the second message 340 in accordance with the second PHY security key SK₂(n) (such as to remove K₂ (n) from the second message 340). To decrypt s(n) from SK₂(n), the reader device 310 may perform a reverse of the operation used by the passive wireless device 315 to encrypt s(n). As described herein, the decryption 360 may include one or more of a decrypting operation and a decoding operation.

$${y}_{T} ( n ) = {h}_{D 1 T} ( n ) {SK}_{1} ( n ) x ( n ) + noise \qquad ( 2 )$$

$${y}_{D 2} ( n ) = ( {h}_{D 1 D 2} ( n ) + {σ}_{f} {h}_{D 1 T} ( n ) {h}_{TD 2} ( n ) {SK}_{2} ( n ) s ( n ) ) x ( n ) + noise \qquad ( 3 )$$

In some implementations, the source device 305 and the reader device 310 may increase (such as double) the security of the backscatter signal by modulating or otherwise modifying the signal x(n) with a third PHY security key SK₃(n) that secures communication between the source device 305 and the reader device 310. In such implementations, the reader device 310 may remove the third PHY security key SK₃(n) upon receiving the signaling (from one or both of the direct link or via the passive wireless device 315). As such, the reader device 310 may receive a signal y (n) as defined in accordance with Equation 4, shown below.

$$y ( n ) = ( {h}_{D 1 D 2} ( n ) + {σ}_{f} {h}_{D 1 T} ( n ) {h}_{TD 2} ( n ) s ( n ) ) {SK}_{3} ( n ) x ( n ) + noise \qquad ( 4 )$$

In some implementations, the source device 305 and the reader device 310 may use the third PHY security key SK₃(n) together with the second PHY security key SK₂(n). In such implementations, the reader device 310 may receive (via a reading from the passive wireless device 315) a signal y_{D2}(n), as defined in accordance with Equation 5, shown below. The passive wireless device 315 may add (such as via encryption, modulation, multiplication, encoding, or other combination techniques) SK₂(n) to s(n), and may leave SK₃(n) (as the passive wireless device 315 may be unaware of SK₃(n)). As such, SK₃(n) may be used by the reader device 310 while reading from the passive wireless device 315 (such as when the source device 305 sends a command or writing to the reader device 310 and the passive wireless device 315 backscatters the command or writing).

$${y}_{D 2} ( n ) = ( {h}_{D 1 D 2} ( n ) + {σ}_{f} {h}_{D 1 T} ( n ) {h}_{TD 2} ( n ) {SK}_{2} ( n ) s ( n ) ) {SK}_{3} ( n ) x ( n ) + noise \qquad ( 5 )$$

The third PHY security key SK₃(n) may be associated with a slower rate or a same rate as s(n) (the signal from the passive wireless device 315). Further, the third PHY security key SK₃(n) may be associated with a faster rate than x(n). For example, SK₃(n) may be associated with a first rate, s(n) may be associated with a second rate, and x(n) may be associated with a third rate, and the first rate may be faster, slower, or the same as the second rate or the third rate. Such a rate may refer to a time rate and may be associated with or define a change of a signal over time (such as a periodicity of a signal or other timing information associated with a signal waveform or frequency of change phase and amplitude over time). Further, x(n) or s(n) may be modulated or unmodulated and may be associated with a single tone signal (such that x(n) or s(n) is associated with a sine wave), a multi-tone signal, an OFDM signal, or a DFT-s-OFDM signal, among other example signals.

In some implementations, the source device 305 may transmit an indication of SK₃(n) to the reader device 310 using secured signaling, such as secured Layer 2 (L2) or Layer 3 (L3) signaling. For example, the source device 305 may transmit an indication of SK₃(n) to the reader device 310 via RRC signaling, a MAC control element (MAC-CE), a secured physical downlink shared channel (PDSCH) message, a secured physical sidelink shared channel (PSSCH) message, or a secured physical uplink shared channel (PUSCH) message. In accordance with signaling SK₃(n) using L2 or L3 secured signaling (or via L1 if secured), the source device 305 and the reader device 310 may avoid or protect against from manipulation of signaling by fake attackers or other types of active attacks.

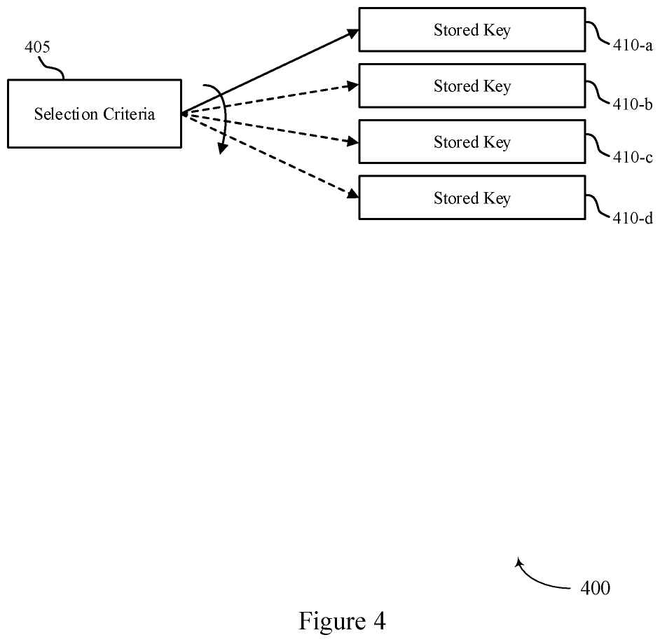

If the reader device 310 sends the read information (such as the signaling that the reader device 310 receives from the source device 305 and the passive wireless device 315) to a network entity 105 without decoding or if the reader device 310 is a same device as the source device 305, the reader device 310 (the backscattering signal receiver) may not need to know SK₃(n) and, in such scenarios, may not expect to receive an indication of SK₃(n). Further, in some implementations, one or more of the source device 305, the reader device 310, and the passive wireless device 315 may support multiple security keys. In such implementations, each of such devices that support multiple security keys may select which key to use from the multiple security keys that are available for use or to switch between available keys in accordance with a key selection procedure. Additional details relating to such a key selection procedure are illustrated by and described with reference to FIG. 4.

FIG. 4 shows an example key selection diagram 400 that supports PHY security for passive IoT devices. The key selection diagram 400 may implement or be implemented to realize aspects of the wireless communications system 100, the network architecture 200, and the signaling diagram 300. For example, one or more of a source device 305, a reader device 310, and a passive wireless device 315 may select one or more PHY security keys in accordance with the key selection diagram 400. As described with reference to FIG. 4, the source device 305, the reader device 310, and the passive wireless device 315 may each be examples of the source device 305, the reader device 310, and the passive wireless device 315 as illustrated by and described with reference to FIG. 3.

In some implementations, the source device 305 and the passive wireless device 315 may switch between available security keys (such as switch between which security keys to use for encryption or decryption) in accordance with a selection criteria 405. For example, the source device 305 and the passive wireless device 315 may select between a stored key 410-a, a stored key 410-b, a stored key 410-c, and a stored key 410-d in accordance with the selection criteria 405. The selection criteria 405 may be associated with a configured rule (such as a stored configured rule), a configuration or indication from another device (such as a configuration or indication to the passive wireless device 315 from the source device 305), a channel estimation, or timers associated with one or more commands (such as one or more kill commands sent to the passive wireless device 315 from the source device 305). As such, one or more of the source device 305, the reader device 310, and the passive wireless device 315 may select a security key from the set of available security keys or switch between available security keys in accordance with using a security key that is generated from a channel, in accordance with using a channel value between the source device 305 to the passive wireless device 315 and between the passive wireless device 315 and the reader device 310, or in accordance with an indication from the source device 305, from the reader device 310, or another network unit or node. Accordingly, the selected security key from the set of available security keys may be the first PHY security key SK₁(n), the second PHY security key SK₂(n), or the third PHY security key SK₃(n).

In implementations in which an indication of which one or more PHY security keys is indicated, the source device 305 (which may be a network entity 105, a UE 115, or another network unit) or the reader device 310 (which may be a network entity 105, a UE 115, or another network unit) may indicate which secret key to use for communication to or from the passive wireless device 315 using an L3 channel such as RRC or PDSCH or another secured channel. In other words, the source device 305 or the reader device 310 may indicate, to each other or to the passive wireless device 315, the secret key to use for tag communication from the source device 305 or for tag communication to the reader device 310, or both.

In implementations in which one or more of the source device 305, the reader device 310, and the passive wireless device 315 use secret key extraction from channel randomness, such devices may send reference signals to each other, measure the reference signals, and calculate, compute, select, ascertain, or otherwise determine a security key in accordance with the measurements of the reference signals. For example, two devices (such as the source device 305 and the passive wireless device 315, the reader device 310 and the passive wireless device 315, or, generally, a network entity 105 and a UE 115), may transmit one or more reference signals to each other and each (or at least one) device may estimate a channel using the one or more reference signals that device receives. In implementations in which the passive wireless device 315 is involved, the reference signals transmitted by the passive wireless device 315 may be reflections of the reference signals received at the passive wireless device 315.

In some implementations, each (or at least one) device may obtain a metric in accordance with the channel. Such a metric may include a channel power, a reference signal receive power (RSRP), a signal-to-interference-plus-noise ratio (SINR), or a phase. The device or devices may quantize the metric or may use the metric as an input into a key derivation function (KDF). For example, a device may set a value of key to be equal to the obtained metric and may calculate a derived key using the key value using derived_key=KDF (key . . . ). In some aspects, a KDF that a device may use may be defined by derived derived_key=HMAC SHA 256 (key, [other parameters]), where such other parameters may include any signaling-related parameters, capability-related parameters, or numeric values.

In some aspects, both of the two devices may calculate a security key using their respective channel metrics. In some scenarios, such as in high signal-to-noise ratio (SNR) scenarios (in which an SNR satisfies a threshold SNR), each of the two devices may expect their respectively derived security keys to be the same and thus secured. Otherwise, such as in relatively low SNR scenarios (in which an SNR fails to satisfy a threshold SNR), the devices may perform some repetition of pilot signals or some other key refinement procedure such that both devices obtain a same security key. As such, the devices may use the derived security key to secure transmissions or secure one or more fields within a physical channel, such as to secure some information carried on a physical control channel or data channel.

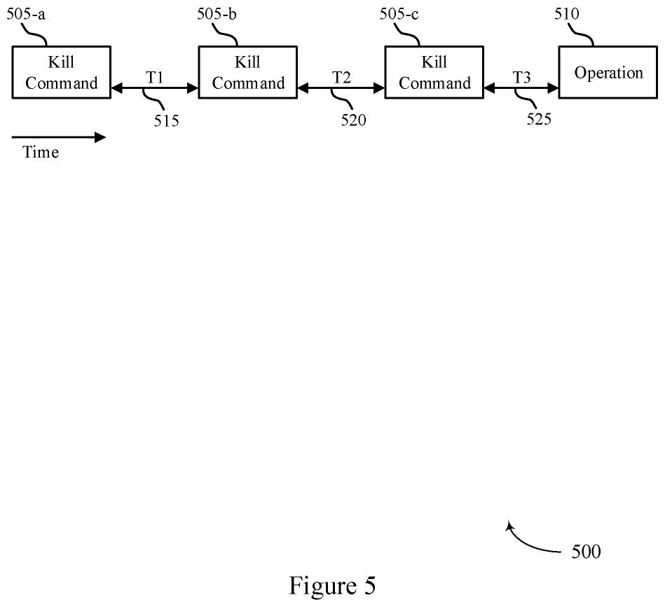

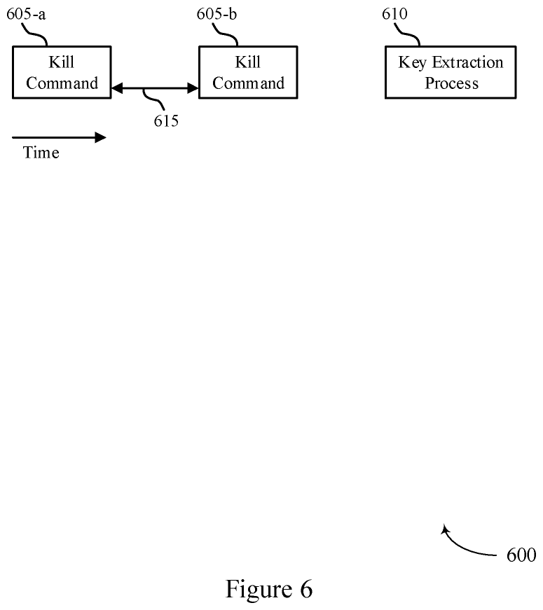

Additionally, or alternatively, one or more of the source device 305, the reader device 310, and the passive wireless device may leverage one or more kill commands as part of a secure key extraction procedure. Additional details relating to such a use of one or more kill commands are illustrated by and described with reference to FIGS. 5 and 6.

FIG. 5 shows an example communication timeline 500 that supports PHY security for passive IoT devices. The communication timeline 500 may implement or be implemented to realize aspects of the wireless communications system 100, the network architecture 200, the signaling diagram 300, or the key selection diagram 400. For example, the communication timeline 500 may illustrate secure key extraction-related communication between two devices, such as between a source device 305 and a passive wireless device 315, between a reader device 310 and the passive wireless device 315, or between the source device 305 and the reader device 310. As described with reference to FIG. 5, the source device 305, the reader device 310, and the passive wireless device 315 may each be examples of the source device 305, the reader device 310, and the passive wireless device 315 as illustrated by and described with reference to FIG. 3.

The source device 305 (which may be a network entity 105) may start or begin communication with the passive wireless device 315 using a password. The source device 305 may use a same password for commands associated with stopping, ceasing, killing, or otherwise terminating communication between the source device 305 and the passive wireless device 315. In some aspects, such a command may be referred to herein as a kill command. In some implementations, the source device 305 and the passive wireless device 315 may use one or more kill commands (which may be secured by a password) to generate one or more PHY security keys for communication to or from the passive wireless device 315. For example, the source device 305 and the passive wireless device 315 may support a mutually understood rule or procedure according to which a key extraction process is associated with a reception of a set of one or more kill commands at known time and frequency locations.

As such, in accordance with receiving a known or expected number (quantity) of kill command occasions (at known or expected time and frequency locations), the passive wireless device 315 may know or expect that the passive wireless device 315 may use a timing of the received kill commands to generate a secure key. For example, the passive wireless device 315 may receive a kill command 505-a, a kill command 505-b, and a kill command 505-c as expected in accordance with the key extraction process (such that the passive wireless device 315 expects the reception of the kill command 505-a, the kill command 505-b, and the kill command 505-c to trigger the key extraction process) and may use timing information associated with the kill commands to calculate, compute, select, ascertain, or otherwise determine a secure key. In some implementations, the passive wireless device 315 may use a first time duration 515 (associated with a T1 value) between the kill command 505-a and the kill command 505-b, a second time duration 520 (associated with a T2 value) between the kill command 505-b and the kill command 505-c, and a third time duration 525 (associated with a T3 value) between the kill command 505-c and an operation 510 (a regular operation, such as an internal operation, a transmit operation, or a receive operation) to generate a secure key.

Accordingly, the passive wireless device 315 may use the times or timers associated with T1, T2, and T3 (and, generally, up to TN), or any combination thereof (such as only T1 and T3), as an input into a KDF to generate the secure key. Such a secure key may be used by any one or more of the source device 305, the reader device 310, and the passive wireless device 315 to secure communication to or from the passive wireless device 315. For example, the passive wireless device 315 may use the generated secure key as the first PHY security key SK₁(n) or the second PHY security key SK₂(n). Attackers may not understand or be able to decrypt the kill commands (as they may be tag-password secured), which may secure such a signaling-based key extraction mechanism.

FIG. 6 shows an example communication timeline 600 that supports PHY security for passive IoT devices. The communication timeline 600 may implement or be implemented to realize aspects of the wireless communications system 100, the network architecture 200, the signaling diagram 300, the key selection diagram 400, or the communication timeline 500. For example, the communication timeline 600 may illustrate secure key extraction-related communication between two devices, such as between a source device 305 and a passive wireless device 315, between a reader device 310 and the passive wireless device 315, or between the source device 305 and the reader device 310. As described with reference to FIG. 6, the source device 305, the reader device 310, and the passive wireless device 315 may each be examples of the source device 305, the reader device 310, and the passive wireless device 315 as illustrated by and described with reference to FIG. 3.

In some implementations, one or more of the source device 305, the reader device 310, and the passive wireless device 315 may use channel-based security key extraction. In implementations in which a device uses channel-based security key extraction involving the passive wireless device 315, the device (such as the source device 305 or the reader device 310) may transmit a set of one or more reference signals to the passive wireless device 315 and the passive wireless device 315 may use the reference signals to estimate a channel from the device to the passive wireless device 315. The device that transmitted the reference signals may use reflections of the reference signals to estimate a channel from the passive wireless device 315 to the device. Accordingly, the devices may obtain a security key using the estimated channels.

In some implementations, such devices may expect such a channel-based key extraction process to start or begin in accordance with a transmission or reception of one or more kill command occasions, which may further increase security associated with the channel-based key extraction process. In other words, transmission or reception of one or more kill commands in accordance with a stored or indicated timing may trigger a channel-based key extraction process to start or begin (such that the timing, if satisfied, is known or expected as a trigger for channel-based key extraction). In some aspects, the timing between a last or final kill command and the channel-based key extraction process may be stored at the passive wireless device 315 or indicated to the passive wireless device 315 (from one or both of the source device 305 and the reader device 310) via L1, L2, or L3 signaling.

For example, and as illustrated by the communication timeline 600, the passive wireless device 315 may receive a kill command 605-a at a first occasion and may receive a kill command 605-b at a second occasion a time duration 615 after the first occasion. As such, if the first occasion, the second occasion, and the time duration 615 between the first occasion and the second occasion is stored or indicated to the passive wireless device 315 as a trigger for a channel-based key extraction process, the passive wireless device 315 may perform a key extraction process 610 accordingly. Further, although described in the context of FIG. 6 as a channel-based key extraction process, the key extraction process 610 may be an example of any key extraction process. As such, one or more of the source device 305, the reader device 310, and the passive wireless device 315 may use channel estimations and timers (such as time between kill commands) to generate a security key (such as using a KDF taking inputs of channel estimation or timing information, or both).

In some implementations, one or more of the source device 305, the reader device 310, and the passive wireless device 315 may obtain a security key from a channel and may use the security key for various operations. For example, such devices may use the security key as a seed to generate another security key using a KDF. In such examples, the security key obtained from the channel may be referred to as an intermediate key and such devices may use the intermediate key as an input into another KDF to obtain a final security key. Additionally, or alternatively, such devices may use the security key as a switch to change a current security key to a different one of the configured, indicated, or stored security keys.

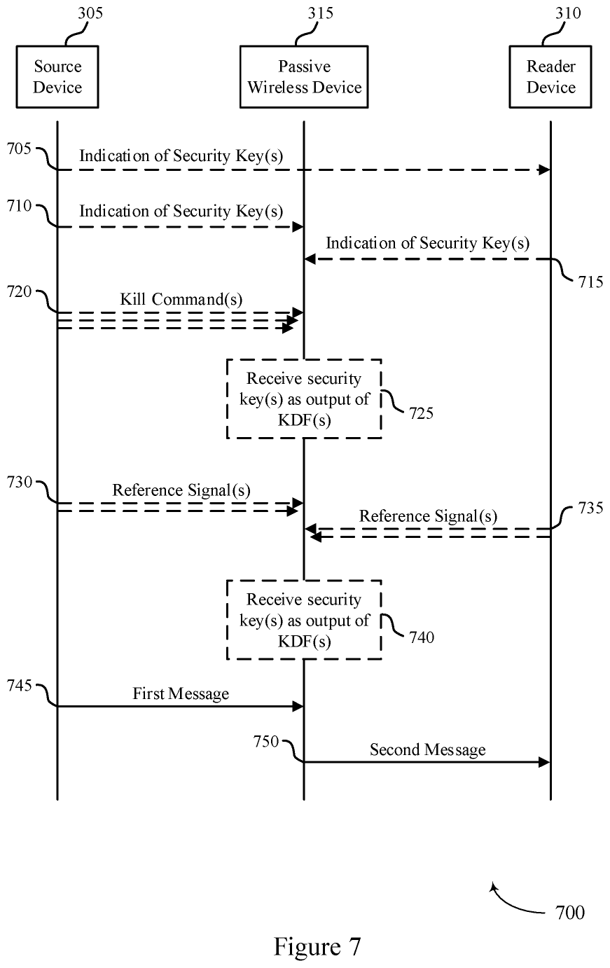

FIG. 7 shows an example process flow 700 that supports PHY security for passive IoT devices. The process flow 700 may implement or be implemented to realize aspects of the wireless communications system 100, the network architecture 200, the signaling diagram 300, the key selection diagram 400, the communication timeline 500, or the communication timeline 600. For example, the process flow 700 may illustrate communication between a source device 305, a reader device 310, and a passive wireless device 315. As described with reference to FIG. 6, the source device 305, the reader device 310, and the passive wireless device 315 may each be examples of the source device 305, the reader device 310, and the passive wireless device 315 as illustrated by and described with reference to FIG. 3.

At 705, the source device 305 may, in some implementations, transmit an indication of one or more security keys to the reader device 310. For example, the source device 305 may transmit, to the reader device 310, an indication of one or both of a first PHY security key SK₁(n) that secures communication between the source device 305 and the passive wireless device 315 and a second PHY security key SK₂(n) that secures communication between the passive wireless device 315 and the reader device 310. In some aspects, the source device 305 may indicate SK₁(n) to the reader device 310 because the reader device 310 may receive a superposition of signaling associated with a direct link between the source device 305 and the reader device 310 and reflected signaling via the passive wireless device 315, which may result in the reader device 310 receiving signaling that is secured with both SK₁(n) and SK₂(n). Additionally, or alternatively, the source device 305 may transmit an indication of a third PHY security key SK₃(n) that secures direct communication between the source device 305 and the reader device 310.

At 710, the source device 305 may, in some implementations, transmit an indication of one or more security keys to the passive wireless device 315. For example, the source device 305 may transmit, to the passive wireless device 315, an indication of one or both of the first PHY security key SK₁(n) that secures communication between the source device 305 and the passive wireless device 315 and the second PHY security key SK₂(n) that secures communication between the passive wireless device 315 and the reader device 310. In some aspects, the passive wireless device 315 may receive a first set of security keys from the source device 305, where each security key of the first set of security keys is usable to secure communication between the source device 305 and the passive wireless device 315. Alternatively, the passive wireless device 315 may receive an indication of the first set of security keys from a different device (such as the reader device 310) or may store the first set of security keys.

At 715, the reader device 310 may, in some implementations, transmit an indication of one or more security keys to the passive wireless device 315. For example, the reader device 310 may transmit, to the passive wireless device 315. For example, the source device 305 may transmit, to the passive wireless device 315, an indication of one or both of the first PHY security key SK₁(n) that secures communication between the source device 305 and the passive wireless device 315 and the second PHY security key SK₂(n) that secures communication between the passive wireless device 315 and the reader device 310. In some aspects, the passive wireless device 315 may receive a second set of security keys from the reader device 310, where each security key of the second set of security keys is usable to secure communication between the reader device 310 and the passive wireless device 315. Alternatively, the passive wireless device 315 may receive an indication of the second set of security keys from a different device (such as the source device 305) or may store the second set of security keys.

At 720, the source device 305 may, in some implementations, transmit a set of one or more kill commands to the passive wireless device 315. In such implementations, the source device 305 and the passive wireless device 315 may support a mutually understood rule or procedure according to which one or more security keys may be obtained using timing information associated with the set of one or more kill commands. Additionally, or alternatively, the source device 305 and the passive wireless device 315 may support a mutually understood rule or procedure according to which the one or more kill commands triggers a channel-based key extraction process.

At 725, for example, the passive wireless device 315 may receive, as an output of one or more KDFs, one or both of the first PHY security key SK₁(n) and the second PHY security key SK₂(n) in accordance with inputting the timing information associated with the kill commands into the one or more KDFs. Additional details relating to such a generation of a security command using timing information associated with multiple kill commands are illustrated by and described with reference to FIG. 5.

At 730, the source device 305 may, in some implementations, transmit a first set of one or more reference signals to the passive wireless device 315. The passive wireless device 315 may obtain a first channel measurement of the first set of one or more reference signals accordingly. In some implementations, the source device 305 may transmit the first set of reference signals and the passive wireless device 315 may expect to receive the first set of one or more reference signals in accordance with receiving the one or more kill commands in accordance with an expected timing that triggers a channel-based key extraction process. In some aspects, the passive wireless device 315 and the source device 305 may be configured, or otherwise set, a fixed time duration between a last command of the set of kill commands received at 720 and the first set of reference signals.

At 735, the reader device 310 may, in some implementations, transmit a second set of one or more reference signals to the passive wireless device 315. The passive wireless device 315 may obtain a second channel measurement of the second set of one or more reference signals accordingly. In some implementations, the reader device 310 may transmit the second set of reference signals and the passive wireless device 315 may expect to receive the second set of one or more reference signals in accordance with receiving the one or more kill commands in accordance with an expected timing that triggers a channel-based key extraction process. In some aspects, the passive wireless device 315 and the reader device 310 may be configured, or otherwise set, a fixed time duration between a last command of the set of kill commands received at 720 and the second set of reference signals.

At 740, the passive wireless device 315 may receive or otherwise obtain, as an output of a first KDF, the first PHY security key SK₁(n) in accordance with inputting a first metric associated with the first channel measurement into the first KDF. Additionally, or alternatively, the passive wireless device 315 may receive or otherwise obtain, as an output of a second KDF, the second PHY security key SK₂(n) in accordance with inputting a second metric associated with the second channel measurement into the second KDF.

At 745, the source device 305 may transmit, to the passive wireless device 315, a first message in accordance with the first PHY security key SK₁(n) that secures communication between the source device 305 and the passive wireless device 315. The first message may include or otherwise be associated with signaling defined by SK₁(n)x(n), where x(n) may convey information (such as data or an identification) from the source device 305. The passive wireless device 315 may decrypt the first message in accordance with performing a reverse of an operation used by the source device 305 to encrypt the x(n) with SK₁(n) and may encrypt information conveyed by the passive wireless device, which may be defined by s(n), with the second PHY security key SK₂(n). Further, in implementations in which the source device 305 additionally encrypts x(n) with SK₃(n), the passive wireless device 315 may expect SK₃(n) to be part of x(n) and may refrain from trying to remove SK₃(n) from x(n).

At 750, the passive wireless device 315 may transmit, to the reader device 310, a second message via a backscattering of the first message and in accordance with the second PHY security key SK₂(n) that secures communication between the passive wireless device 315 and the reader device 310. The second message may include or otherwise be associated with signaling defined by SK₂(n)s(n)x(n), where s(n) may convey information (such as data or an identification) from the passive wireless device 315 and x(n) may be an unmodulated signal (such as a single tone signal or a multi-tone signal, among other example signals) from the source device 305 (to be backscattered by the passive wireless device 315). The reader device 310 may decrypt the second message in accordance with performing a reverse of an operation used by the passive wireless device 315 to encrypt s(n) with SK₂(n) and, accordingly, may receive the signal defined by s(n)x(n). In implementations in which the source device 305 additionally encrypts x(n) with SK₃(n), the reader device 310 may additionally decrypt the second message to remove the impact of SK₃(n).

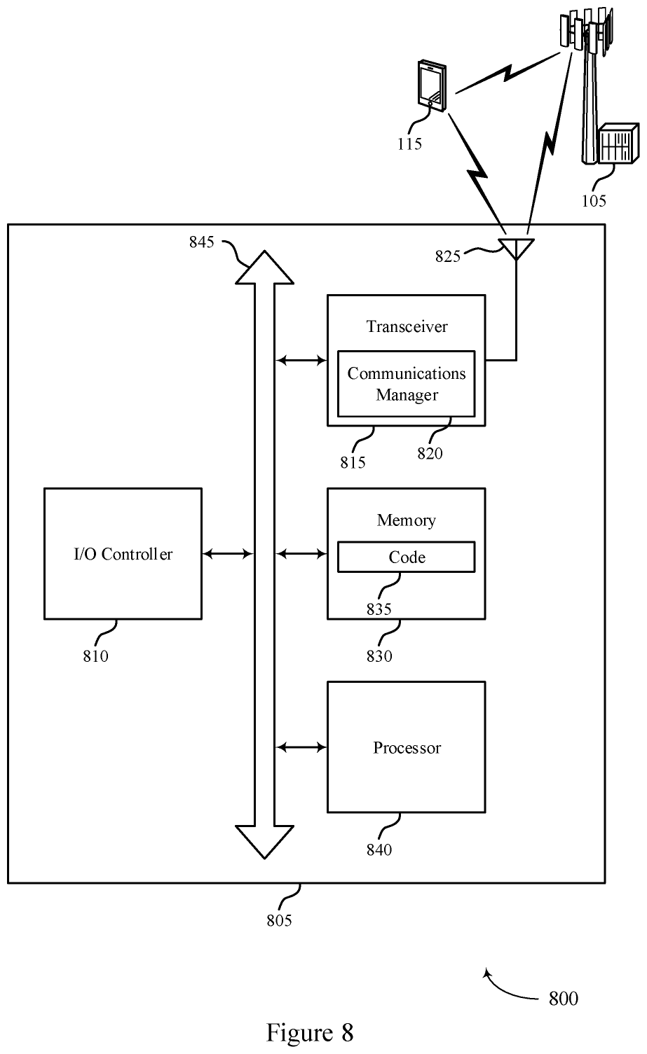

FIG. 8 shows a block diagram 800 of an example device 805 that supports PHY security for passive IoT devices. The device 805 may communicate (such as wirelessly) with one or more network entities (such as one or more components of one or more network entities 105), one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (such as operatively, communicatively, functionally, electronically, electrically) via one or more buses (such as a bus 845).

The I/O controller 810 may manage input and output signals for the device 805. The I/O controller 810 also may manage peripherals not integrated into the device 805. In some implementations, the I/O controller 810 may represent a physical connection or port to an external peripheral. In some implementations, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some implementations, the I/O controller 810 may be implemented as part of a processor or processing system, such as the processor 840. In some implementations, a user may interact with the device 805 via the I/O controller 810 or via hardware components controlled by the I/O controller 810.

In some implementations, the device 805 may include a single antenna 825. However, in some other implementations, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 also may include a modem to modulate the packets, to provide the modulated packets to one or more antennas 825 for transmission, and to demodulate packets received from the one or more antennas 825. In some implementations, the transceiver 815 may include one or more interfaces, such as one or more interfaces coupled with the one or more antennas 825 that are configured to support various receiving or obtaining operations, or one or more interfaces coupled with the one or more antennas 825 that are configured to support various transmitting or outputting operations, or a combination thereof. In some implementations, the transceiver 815 may include or be configured for coupling with one or more processors or memory components that are operable to perform or support operations associated with received or obtained information or signals, or to generate information or other signals for transmission or other outputting, or any combination thereof. In some implementations, the transceiver 815, or the transceiver 815 and the one or more antennas 825, or the transceiver 815 and the one or more antennas 825 and one or more processors or memory components (such as the processor 840, or the memory 830, or both), may be included in a chip or chip assembly that is installed in the device 805.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some implementations, the code 835 may not be directly executable by the processor 840 but may cause a computer (such as when compiled and executed) to perform functions described herein. In some implementations, the memory 830 may contain, among other things, a basic I/O system (BIOS) which may control basic hardware or software operation such as the interaction with peripheral components or devices.

The processor 840 may be any one or more suitable processors capable of executing scripts or instructions of one or more software programs stored in the device 805 (such as within the memory 830). In some implementations, the processor 840 may be a component of a processing system. A processing system may generally refer to a system or series of machines or components that receives inputs and processes the inputs to produce a set of outputs (which may be passed to other systems or components of, for example, the device 805). For example, a processing system of the device 805 may refer to a system including the various other components or subcomponents of the device 805, such as the processor 840, or the transceiver 815, or the communications manager 820, or other components or combinations of components of the device 805. The processing system of the device 805 may interface with other components of the device 805, and may process information received from other components (such as inputs or signals) or output information to other components. For example, a chip or modem of the device 805 may include a processing system and an interface to output information, or to obtain information, or both. The interface may be implemented as or otherwise include a first interface configured to output information and a second interface configured to obtain information. In some implementations, the first interface may refer to an interface between the processing system of the chip or modem and a transmitter, such that the device 805 may transmit information output from the chip or modem. In some implementations, the second interface may refer to an interface between the processing system of the chip or modem and a receiver, such that the device 805 may obtain information or signal inputs, and the information may be passed to the processing system. A person having ordinary skill in the art will readily recognize that the first interface also may obtain information or signal inputs, and the second interface also may output information or signal outputs.

The communications manager 820 may support wireless communications at a passive wireless device in accordance with examples as disclosed herein. For example, the communications manager 820 may be configured as or otherwise support a means for receiving a first message in accordance with a first PHY security key that secures communication between a source device and the passive wireless device. The communications manager 820 may be configured as or otherwise support a means for transmitting a second message via a backscattering of the first message and in accordance with a second PHY security key that secures communication between the passive wireless device and a reader device.

In some implementations, the communications manager 820 may be configured as or otherwise support a means for receiving, from one or both of the source device and the reader device, an indication of the first PHY security key, the second PHY security key, or a combination thereof.

In some implementations, the communications manager 820 may be configured as or otherwise support a means for receiving a set of multiple commands associated with a termination of the communication between the source device and the passive wireless device. In some implementations, the communications manager 820 may be configured as or otherwise support a means for receiving, as an output of one or more key derivation functions, one or both of the first PHY security key and the second PHY security key in accordance with inputting timing information associated with the set of multiple commands into the one or more key derivation functions.

In some implementations, the communications manager 820 may be configured as or otherwise support a means for receiving, from the source device, a first set of one or more reference signals, where the first PHY security key is associated with a first channel measurement of the first set of one or more reference signals. In some implementations, the communications manager 820 may be configured as or otherwise support a means for receiving, from the reader device, a second set of one or more reference signals, where the second PHY security key is associated with a second channel measurement of the second set of one or more reference signals.

In some implementations, the communications manager 820 may be configured as or otherwise support a means for receiving, as an output of a first key derivation function, the first PHY security key in accordance with inputting a first metric associated with the first channel measurement into the first key derivation function. In some implementations, the communications manager 820 may be configured as or otherwise support a means for receiving, as an output of a second key derivation function, the second PHY security key in accordance with inputting a second metric associated with the second channel measurement into the second key derivation function.

In some implementations, the communications manager 820 may be configured as or otherwise support a means for receiving a set of one or more commands associated with a termination of the communication between the source device and the passive wireless device, where a timing of one or both of the first set of one or more reference signals and the second set of one or more reference signals is associated with the set of one or more commands, where the timing is further associated with a fixed time duration between a last command of the set of one or more commands and one or both of the first set of one or more reference signals and the second set of one or more reference signals.

In some implementations, the communications manager 820 may be configured as or otherwise support a means for receiving, as an output of a first key derivation function, an intermediate first PHY security key in accordance with inputting a first metric associated with the first channel measurement into the first key derivation function. In some implementations, the communications manager 820 may be configured as or otherwise support a means for receiving, as an output of a second key derivation function, the first PHY security key in accordance with inputting the intermediate first PHY security key into the second key derivation function.

In some implementations, the communications manager 820 may be configured as or otherwise support a means for receiving, as an output of a first key derivation function, an intermediate second PHY security key in accordance with inputting a second metric associated with the second channel measurement into the first key derivation function. In some implementations, the communications manager 820 may be configured as or otherwise support a means for receiving, as an output of a second key derivation function, the second PHY security key in accordance with inputting the intermediate second PHY security key into the second key derivation function.

In some implementations, the communications manager 820 may be configured as or otherwise support a means for receiving an indication of a first set of PHY security keys that secures communication between the source device and the passive wireless device, where a selection of the first PHY security key from the first set of PHY security keys is associated with the indication of the first set of PHY security keys.

In some implementations, the selection of the first PHY security key from the first set of PHY security keys is associated with an indication of the selection by the source device, a first channel measurement of a first channel between the source device and the passive wireless device, timing information of a set of multiple commands associated with a termination of the communication between the source device and the passive wireless device, or any combination thereof.

In some implementations, the communications manager 820 may be configured as or otherwise support a means for receiving an indication of a second set of PHY security keys that secures communication between the passive wireless device and the reader device, where a selection of the second PHY security key from the second set of PHY security keys is associated with the indication of the second set of PHY security keys.

In some implementations, the selection of the second PHY security key from the second set of PHY security keys is associated with an indication of the selection by the source device or the reader device, a second channel measurement of a second channel between the reader device and the passive wireless device, timing information of a set of multiple commands associated with a termination of the communication between the source device and the passive wireless device, or any combination thereof.

In some implementations, the first PHY security key and the second PHY security key are stored at the passive wireless device prior to receiving the first message and transmitting the second message.

In some implementations, a first modulation operation, a first multiplication operation, or a first logical XOR operation, and where the communication between the reader device and the passive wireless device is secured in accordance with performing a second operation on the second message and the first PHY security key, the second operation including one or more of. In some implementations, a second modulation operation, a second multiplication operation, or a second logical XOR operation.

In some implementations, the first message corresponds to a first radio wave associated with a first set of bits and the second message corresponds to a second radio wave associated with a second set of bits. In some implementations, the backscattering by the passive wireless device is associated with an amplitude shift keying modulation of the first set of bits with the second set of bits via selective reflection by the passive wireless device.

Additionally, or alternatively, the communications manager 820 may support wireless communications at a reader device in accordance with examples as disclosed herein. For example, the communications manager 820 may be configured as or otherwise support a means for receiving a first message from a source device via a passive wireless device, the passive wireless device associated with a backscattering of the first message. The communications manager 820 may be configured as or otherwise support a means for decrypting the first message in accordance with a PHY security key that secures communication between the passive wireless device and the reader device.

In some implementations, the communications manager 820 may be configured as or otherwise support a means for receiving an indication of the PHY security key.

In some implementations, the communications manager 820 may be configured as or otherwise support a means for transmitting, to the passive wireless device, a set of one or more reference signals, where the PHY security key is associated with a channel measurement of the set of one or more reference signals.

In some implementations, the communications manager 820 may be configured as or otherwise support a means for receiving, as an output of a key derivation function, the PHY security key in accordance with inputting a metric associated with the channel measurement into the key derivation function.

In some implementations, the communications manager 820 may be configured as or otherwise support a means for receiving, as an output of a first key derivation function, an intermediate PHY security key in accordance with inputting a metric associated with the channel measurement into the first key derivation function. In some implementations, the communications manager 820 may be configured as or otherwise support a means for receiving, as an output of a second key derivation function, the PHY security key in accordance with inputting the intermediate PHY security key into the second key derivation function.

In some implementations, the communications manager 820 may be configured as or otherwise support a means for receiving an indication of a set of PHY security keys that secures communication between the passive wireless device and the reader device, where a selection of the PHY security key from the set of PHY security keys is associated with the indication of the set of PHY security keys.

In some implementations, the selection of the PHY security key from the set of PHY security keys is associated with an indication of the selection by the source device to the reader device, a channel measurement of a channel between the reader device and the passive wireless device, timing information of a set of multiple commands associated with a termination of the communication between the source device and the passive wireless device, or any combination thereof.

In some implementations, to support receiving the first message, the communications manager 820 may be configured as or otherwise support a means for receiving the first message in accordance with a second PHY security key that secures communication between the source device and the reader device.

In some implementations, the communications manager 820 may be configured as or otherwise support a means for receiving an indication of the second PHY security key.

In some implementations, the communications manager 820 may be configured as or otherwise support a means for transmitting, to the passive wireless device, a second message in accordance with a second PHY security key that secures communication between the reader device and the passive wireless device, where the source device and the reader device are a same device, and where the first message is a backscattered version of the second message.

Additionally, or alternatively, the communications manager 820 may support wireless communications at a source device in accordance with examples as disclosed herein. For example, the communications manager 820 may be configured as or otherwise support a means for encrypting a first message in accordance with a PHY security key that secures communication between the source device and a passive wireless device. The communications manager 820 may be configured as or otherwise support a means for transmitting the first message to a reader device via the passive wireless device, the passive wireless device associated with a backscattering of the first message.

In some implementations, the communications manager 820 may be configured as or otherwise support a means for transmitting, to the passive wireless device, an indication of the PHY security key.

In some implementations, the communications manager 820 may be configured as or otherwise support a means for transmitting, to the passive wireless device, a set of multiple commands associated with a termination of the communication between the source device and the passive wireless device. In some implementations, the communications manager 820 may be configured as or otherwise support a means for receiving, as an output of a key derivation function, the PHY security key in accordance with inputting timing information associated with the set of multiple commands into the key derivation function.

In some implementations, the communications manager 820 may be configured as or otherwise support a means for transmitting, to the passive wireless device, a set of one or more reference signals, where the PHY security key is associated with a channel measurement of the set of one or more reference signals.

In some implementations, the communications manager 820 may be configured as or otherwise support a means for receiving, as an output of a key derivation function, the PHY security key in accordance with inputting a metric associated with the channel measurement into the key derivation function.

In some implementations, the communications manager 820 may be configured as or otherwise support a means for transmitting, to the passive wireless device, a set of one or more commands associated with a termination of the communication between the source device and the passive wireless device, where a timing of the set of one or more reference signals is associated with the set of one or more commands, where the timing is further associated with a fixed time duration between a last command of the set of one or more commands and the set of one or more reference signals.

In some implementations, the communications manager 820 may be configured as or otherwise support a means for receiving, as an output of a first key derivation function, an intermediate PHY security key in accordance with inputting a metric associated with the channel measurement into the first key derivation function. In some implementations, the communications manager 820 may be configured as or otherwise support a means for receiving, as an output of a second key derivation function, the PHY security key in accordance with inputting the intermediate PHY security key into the second key derivation function.

In some implementations, the communications manager 820 may be configured as or otherwise support a means for transmitting, to the passive wireless device, an indication of a set of PHY security keys that secures communication between the source device and the passive wireless device, where a selection of the PHY security key from the set of PHY security keys is associated with the indication of the set of PHY security keys.

In some implementations, the selection of the PHY security key from the set of PHY security keys is associated with an indication of the selection by the source device to the passive wireless device, a channel measurement of a channel between the source device and the passive wireless device, timing information of a set of multiple commands associated with a termination of the communication between the source device and the passive wireless device, or any combination thereof.

In some implementations, the communications manager 820 may be configured as or otherwise support a means for transmitting, to one or both of the passive wireless device and the reader device, an indication of a second PHY security key that secures communication between the passive wireless device and the reader device.

In some implementations, the communications manager 820 may be configured as or otherwise support a means for transmitting, to one or both of the passive wireless device and the reader device, an indication of a second set of PHY security keys that secures communication between the passive wireless device and the reader device, where a selection of a second PHY security key from the second set of PHY security keys is associated with the indication of the second set of PHY security keys.

In some implementations, the selection of the second PHY security key from the second set of PHY security keys is associated with an indication of the selection by the source device to the passive wireless device, a channel measurement of a channel between the reader device and the passive wireless device, timing information of a set of multiple commands associated with a termination of the communication between the source device and the passive wireless device, or any combination thereof.

In some implementations, to support transmitting the first message, the communications manager 820 may be configured as or otherwise support a means for transmitting the first message in accordance with a second PHY security key that secures communication between the source device and the reader device.

In some implementations, the communications manager 820 may be configured as or otherwise support a means for transmitting, to the reader device, an indication of the second PHY security key.

In some implementations, the communications manager 820 may be configured as or otherwise support a means for receiving, from the passive wireless device, a second message in accordance with a second PHY security key that secures communication between the passive wireless device and the reader device, where the source device and the reader device are a same device, and where the second message is a backscattered version of the first message.

In some implementations, the communications manager 820 may be configured to perform various operations (such as receiving, monitoring, transmitting) using or otherwise in cooperation with the transceiver 815, the one or more antennas 825, or any combination thereof. Although the communications manager 820 is illustrated as a separate component, in some implementations, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of PHY security for passive IoT devices as described herein, or the processor 840 and the memory 830 may be otherwise configured to perform or support such operations.

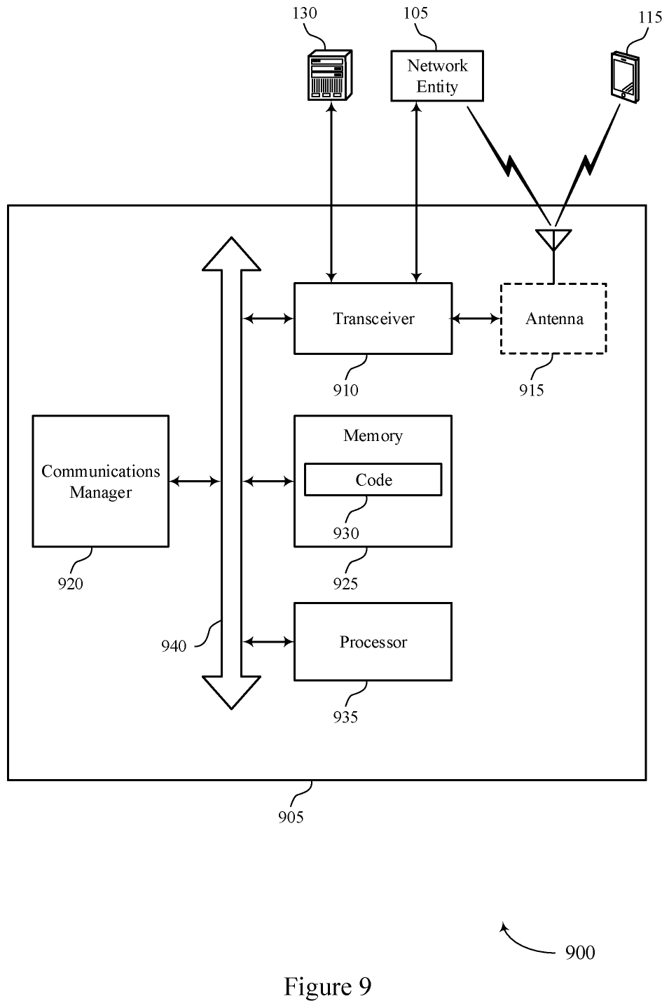

FIG. 9 shows a block diagram 900 of an example device 905 that supports PHY security for passive IoT devices. The device 905 may communicate with one or more network entities (such as one or more components of one or more network entities 105), one or more UEs 115, or any combination thereof, which may include communications over one or more wired interfaces, over one or more wireless interfaces, or any combination thereof. The device 905 may include components that support outputting and obtaining communications, such as a communications manager 920, a transceiver 910, an antenna 915, a memory 925, code 930, and a processor 935. These components may be in electronic communication or otherwise coupled (such as operatively, communicatively, functionally, electronically, electrically) via one or more buses (such as a bus 940).

The transceiver 910 may support bi-directional communications via wired links, wireless links, or both as described herein. In some implementations, the transceiver 910 may include a wired transceiver and may communicate bi-directionally with another wired transceiver. Additionally, or alternatively, in some implementations, the transceiver 910 may include a wireless transceiver and may communicate bi-directionally with another wireless transceiver. In some implementations, the device 905 may include one or more antennas 915, which may be capable of transmitting or receiving wireless transmissions (such as concurrently). The transceiver 910 also may include a modem to modulate signals, to provide the modulated signals for transmission (such as by one or more antennas 915, by a wired transmitter), to receive modulated signals (such as from one or more antennas 915, from a wired receiver), and to demodulate signals. In some implementations, the transceiver may be operable to support communications via one or more communications links (such as a communication link 125, a backhaul communication link 120, a midhaul communication link 162, a fronthaul communication link 168).

The memory 925 may include RAM and ROM. The memory 925 may store computer-readable, computer-executable code 930 including instructions that, when executed by the processor 935, cause the device 905 to perform various functions described herein. The code 930 may be stored in a non-transitory computer-readable medium such as system memory or another type of memory. In some implementations, the code 930 may not be directly executable by the processor 935 but may cause a computer (such as when compiled and executed) to perform functions described herein. In some implementations, the memory 925 may contain, among other things, a BIOS which may control basic hardware or software operation such as the interaction with peripheral components or devices.

The processor 935 may include an intelligent hardware device (such as a general-purpose processor, a DSP, an ASIC, a CPU, an FPGA, a microcontroller, a programmable logic device, discrete gate or transistor logic, a discrete hardware component, or any combination thereof). In some implementations, the processor 935 may be configured to operate a memory array using a memory controller. In some other implementations, a memory controller may be integrated into the processor 935. The processor 935 may be configured to execute computer-readable instructions stored in a memory (such as the memory 925) to cause the device 905 to perform various functions (such as functions or tasks supporting PHY security for passive IoT devices). For example, the device 905 or a component of the device 905 may include a processor 935 and memory 925 coupled with the processor 935, the processor 935 and memory 925 configured to perform various functions described herein. The processor 935 may be an example of a cloud-computing platform (such as one or more physical nodes and supporting software such as operating systems, virtual machines, or container instances) that may host the functions (such as by executing code 930) to perform the functions of the device 905.

In some implementations, a bus 940 may support communications of (such as within) a protocol layer of a protocol stack. In some implementations, a bus 940 may support communications associated with a logical channel of a protocol stack (such as between protocol layers of a protocol stack), which may include communications performed within a component of the device 905, or between different components of the device 905 that may be co-located or located in different locations (such as where the device 905 may refer to a system in which one or more of the communications manager 920, the transceiver 910, the memory 925, the code 930, and the processor 935 may be located in one of the different components or divided between different components).

In some implementations, the communications manager 920 may manage aspects of communications with a core network 130 (such as via one or more wired or wireless backhaul links). For example, the communications manager 920 may manage the transfer of data communications for client devices, such as one or more UEs 115. In some implementations, the communications manager 920 may manage communications with other network entities 105, and may include a controller or scheduler for controlling communications with UEs 115 in cooperation with other network entities 105. In some implementations, the communications manager 920 may support an X2 interface within an LTE/LTE-A wireless communications network technology to provide communication between network entities 105.

The communications manager 920 may support wireless communications at a reader device in accordance with examples as disclosed herein. For example, the communications manager 920 may be configured as or otherwise support a means for receiving a first message from a source device via a passive wireless device, the passive wireless device associated with a backscattering of the first message. The communications manager 920 may be configured as or otherwise support a means for decrypting the first message in accordance with a PHY security key that secures communication between the passive wireless device and the reader device.

In some implementations, the communications manager 920 may be configured as or otherwise support a means for receiving an indication of the PHY security key.

In some implementations, the communications manager 920 may be configured as or otherwise support a means for transmitting, to the passive wireless device, a set of one or more reference signals, where the PHY security key is associated with a channel measurement of the set of one or more reference signals.

In some implementations, the communications manager 920 may be configured as or otherwise support a means for receiving, as an output of a key derivation function, the PHY security key in accordance with inputting a metric associated with the channel measurement into the key derivation function.

In some implementations, the communications manager 920 may be configured as or otherwise support a means for receiving, as an output of a first key derivation function, an intermediate PHY security key in accordance with inputting a metric associated with the channel measurement into the first key derivation function. In some implementations, the communications manager 920 may be configured as or otherwise support a means for receiving, as an output of a second key derivation function, the PHY security key in accordance with inputting the intermediate PHY security key into the second key derivation function.

In some implementations, the communications manager 920 may be configured as or otherwise support a means for receiving an indication of a set of PHY security keys that secures communication between the passive wireless device and the reader device, where a selection of the PHY security key from the set of PHY security keys is associated with the indication of the set of PHY security keys.

In some implementations, the selection of the PHY security key from the set of PHY security keys is associated with an indication of the selection by the source device to the reader device, a channel measurement of a channel between the reader device and the passive wireless device, timing information of a set of multiple commands associated with a termination of the communication between the source device and the passive wireless device, or any combination thereof.

In some implementations, to support receiving the first message, the communications manager 920 may be configured as or otherwise support a means for receiving the first message in accordance with a second PHY security key that secures communication between the source device and the reader device.

In some implementations, the communications manager 920 may be configured as or otherwise support a means for receiving an indication of the second PHY security key.

In some implementations, the communications manager 920 may be configured as or otherwise support a means for transmitting, to the passive wireless device, a second message in accordance with a second PHY security key that secures communication between the reader device and the passive wireless device, where the source device and the reader device are a same device, and where the first message is a backscattered version of the second message.

Additionally, or alternatively, the communications manager 920 may support wireless communications at a source device in accordance with examples as disclosed herein. For example, the communications manager 920 may be configured as or otherwise support a means for encrypting a first message in accordance with a PHY security key that secures communication between the source device and a passive wireless device. The communications manager 920 may be configured as or otherwise support a means for transmitting the first message to a reader device via the passive wireless device, the passive wireless device associated with a backscattering of the first message.

In some implementations, the communications manager 920 may be configured as or otherwise support a means for transmitting, to the passive wireless device, an indication of the PHY security key.

In some implementations, the communications manager 920 may be configured as or otherwise support a means for transmitting, to the passive wireless device, a set of multiple commands associated with a termination of the communication between the source device and the passive wireless device. In some implementations, the communications manager 920 may be configured as or otherwise support a means for receiving, as an output of a key derivation function, the PHY security key in accordance with inputting timing information associated with the set of multiple commands into the key derivation function.

In some implementations, the communications manager 920 may be configured as or otherwise support a means for transmitting, to the passive wireless device, a set of one or more reference signals, where the PHY security key is associated with a channel measurement of the set of one or more reference signals.

In some implementations, the communications manager 920 may be configured as or otherwise support a means for receiving, as an output of a key derivation function, the PHY security key in accordance with inputting a metric associated with the channel measurement into the key derivation function.

In some implementations, the communications manager 920 may be configured as or otherwise support a means for transmitting, to the passive wireless device, a set of one or more commands associated with a termination of the communication between the source device and the passive wireless device, where a timing of the set of one or more reference signals is associated with the set of one or more commands, where the timing is further associated with a fixed time duration between a last command of the set of one or more commands and the set of one or more reference signals.

In some implementations, the communications manager 920 may be configured as or otherwise support a means for receiving, as an output of a first key derivation function, an intermediate PHY security key in accordance with inputting a metric associated with the channel measurement into the first key derivation function. In some implementations, the communications manager 920 may be configured as or otherwise support a means for receiving, as an output of a second key derivation function, the PHY security key in accordance with inputting the intermediate PHY security key into the second key derivation function.

In some implementations, the communications manager 920 may be configured as or otherwise support a means for transmitting, to the passive wireless device, an indication of a set of PHY security keys that secures communication between the source device and the passive wireless device, where a selection of the PHY security key from the set of PHY security keys is associated with the indication of the set of PHY security keys.

In some implementations, the selection of the PHY security key from the set of PHY security keys is associated with an indication of the selection by the source device to the passive wireless device, a channel measurement of a channel between the source device and the passive wireless device, timing information of a set of multiple commands associated with a termination of the communication between the source device and the passive wireless device, or any combination thereof.

In some implementations, the communications manager 920 may be configured as or otherwise support a means for transmitting, to one or both of the passive wireless device and the reader device, an indication of a second PHY security key that secures communication between the passive wireless device and the reader device.

In some implementations, the communications manager 920 may be configured as or otherwise support a means for transmitting, to one or both of the passive wireless device and the reader device, an indication of a second set of PHY security keys that secures communication between the passive wireless device and the reader device, where a selection of a second PHY security key from the second set of PHY security keys is associated with the indication of the second set of PHY security keys.

In some implementations, the selection of the second PHY security key from the second set of PHY security keys is associated with an indication of the selection by the source device to the passive wireless device, a channel measurement of a channel between the reader device and the passive wireless device, timing information of a set of multiple commands associated with a termination of the communication between the source device and the passive wireless device, or any combination thereof.

In some implementations, to support transmitting the first message, the communications manager 920 may be configured as or otherwise support a means for transmitting the first message in accordance with a second PHY security key that secures communication between the source device and the reader device.

In some implementations, the communications manager 920 may be configured as or otherwise support a means for transmitting, to the reader device, an indication of the second PHY security key.

In some implementations, the communications manager 920 may be configured as or otherwise support a means for receiving, from the passive wireless device, a second message in accordance with a second PHY security key that secures communication between the passive wireless device and the reader device, where the source device and the reader device are a same device, and where the second message is a backscattered version of the first message.

In some implementations, the communications manager 920 may be configured to perform various operations (such as receiving, obtaining, monitoring, outputting, transmitting) using or otherwise in cooperation with the transceiver 910, the one or more antennas 915 (such as where applicable), or any combination thereof. Although the communications manager 920 is illustrated as a separate component, in some implementations, one or more functions described with reference to the communications manager 920 may be supported by or performed by the processor 935, the memory 925, the code 930, the transceiver 910, or any combination thereof. For example, the code 930 may include instructions executable by the processor 935 to cause the device 905 to perform various aspects of PHY security for passive IoT devices as described herein, or the processor 935 and the memory 925 may be otherwise configured to perform or support such operations.

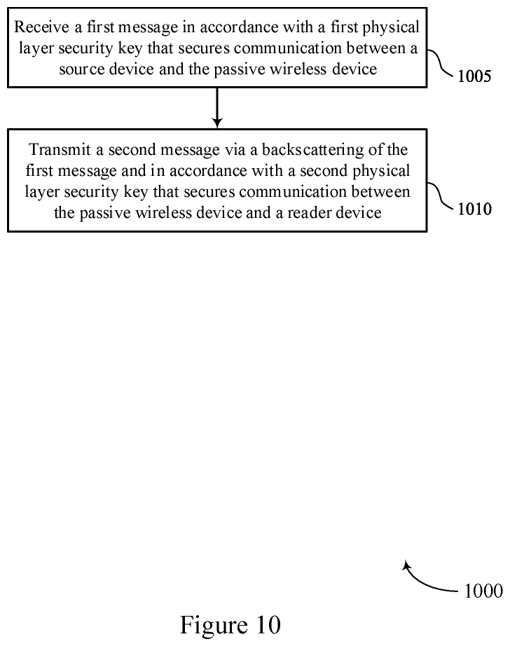

FIG. 10 shows a flowchart illustrating an example method 1000 that supports PHY security for passive IoT devices. The operations of the method 1000 may be implemented by a UE or its components as described herein. For example, the operations of the method 1000 may be performed by a UE 115 as described with reference to FIGS. 1-8. In some implementations, a UE may execute a set of instructions to control the functional elements of the UE to perform the described functions. Additionally, or alternatively, the UE may perform aspects of the described functions using special-purpose hardware.

At 1005, the method may include receiving a first message in accordance with a first PHY security key that secures communication between a source device and the passive wireless device. The operations of 1005 may be performed in accordance with examples as disclosed herein. In some implementations, aspects of the operations of 1005 may be performed by a communications manager 820 as described with reference to FIG. 8.

At 1010, the method may include transmitting a second message via a backscattering of the first message and in accordance with a second PHY security key that secures communication between the passive wireless device and a reader device. The operations of 1010 may be performed in accordance with examples as disclosed herein. In some implementations, aspects of the operations of 1010 may be performed by a communications manager 820 as described with reference to FIG. 8.

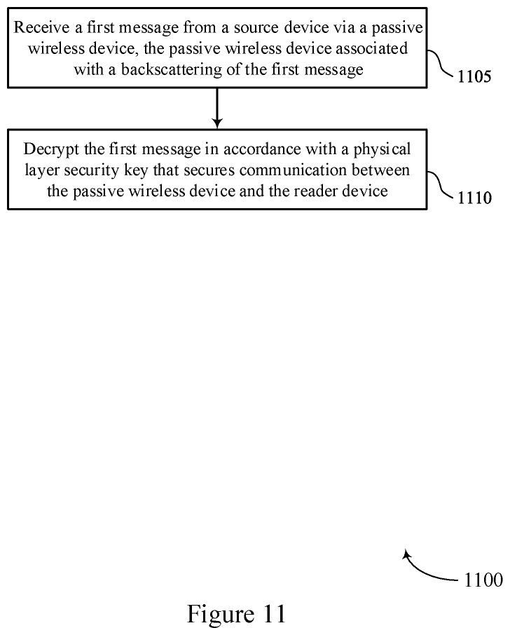

FIG. 11 shows a flowchart illustrating an example method 1100 that supports PHY security for passive IoT devices. The operations of the method 1100 may be implemented by a UE or a network entity or its components as described herein. For example, the operations of the method 1100 may be performed by a UE 115 as described with reference to FIGS. 1-8 or a network entity as described with reference to FIGS. 1-9. In some implementations, a UE or a network entity may execute a set of instructions to control the functional elements of the UE or the network entity to perform the described functions. Additionally, or alternatively, the UE or the network entity may perform aspects of the described functions using special-purpose hardware.

At 1105, the method may include receiving a first message from a source device via a passive wireless device, the passive wireless device associated with a backscattering of the first message. The operations of 1105 may be performed in accordance with examples as disclosed herein. In some implementations, aspects of the operations of 1105 may be performed by a communications manager 820 or a communications manager 920 as described with reference to FIGS. 8 and 9.

At 1110, the method may include decrypting the first message in accordance with a PHY security key that secures communication between the passive wireless device and the reader device. The operations of 1110 may be performed in accordance with examples as disclosed herein. In some implementations, aspects of the operations of 1110 may be performed by a communications manager 820 or a communications manager 920 as described with reference to FIGS. 8 and 9.

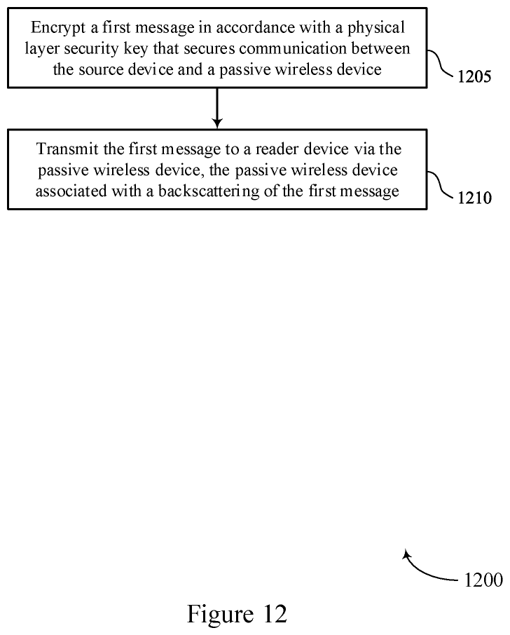

FIG. 12 shows a flowchart illustrating an example method 1200 that supports PHY security for passive IoT devices. The operations of the method 1200 may be implemented by a UE or a network entity or its components as described herein. For example, the operations of the method 1200 may be performed by a UE 115 as described with reference to FIGS. 1-8 or a network entity as described with reference to FIGS. 1-9. In some implementations, a UE or a network entity may execute a set of instructions to control the functional elements of the UE or the network entity to perform the described functions. Additionally, or alternatively, the UE or the network entity may perform aspects of the described functions using special-purpose hardware.

At 1205, the method may include encrypting a first message in accordance with a PHY security key that secures communication between the source device and a passive wireless device. The operations of 1205 may be performed in accordance with examples as disclosed herein. In some implementations, aspects of the operations of 1205 may be performed by a communications manager 820 or a communications manager 920 as described with reference to FIGS. 8 and 9.

At 1210, the method may include transmitting the first message to a reader device via the passive wireless device, the passive wireless device associated with a backscattering of the first message. The operations of 1210 may be performed in accordance with examples as disclosed herein. In some implementations, aspects of the operations of 1210 may be performed by a communications manager 820 or a communications manager 920 as described with reference to FIGS. 8 and 9. The following provides an overview of some aspects of the present disclosure:

Aspect 1: A method for wireless communications at a passive wireless device, including: receiving a first message in accordance with a first physical layer security key that secures communication between a source device and the passive wireless device; and transmitting a second message via a backscattering of the first message and in accordance with a second physical layer security key that secures communication between the passive wireless device and a reader device.

Aspect 2: The method of aspect 1, further including: receiving, from one or both of the source device and the reader device, an indication of the first physical layer security key, the second physical layer security key, or a combination thereof.

Aspect 3: The method of any of aspects 1-2, further including: receiving a set of multiple commands associated with a termination of the communication between the source device and the passive wireless device; and receiving, as an output of one or more key derivation functions, one or both of the first physical layer security key and the second physical layer security key in accordance with inputting timing information associated with the set of multiple commands into the one or more key derivation functions.

Aspect 4: The method of any of aspects 1-3, further including: receiving, from the source device, a first set of one or more reference signals, where the first physical layer security key is associated with a first channel measurement of the first set of one or more reference signals; and receiving, from the reader device, a second set of one or more reference signals, where the second physical layer security key is associated with a second channel measurement of the second set of one or more reference signals.

Aspect 5: The method of aspect 4, further including: receiving, as an output of a first key derivation function, the first physical layer security key in accordance with inputting a first metric associated with the first channel measurement into the first key derivation function; and receiving, as an output of a second key derivation function, the second physical layer security key in accordance with inputting a second metric associated with the second channel measurement into the second key derivation function.

Aspect 6: The method of any of aspects 4-5, further including: receiving a set of one or more commands associated with a termination of the communication between the source device and the passive wireless device, where a timing of one or both of the first set of one or more reference signals and the second set of one or more reference signals is associated with the set of one or more commands, where the timing is further associated with a fixed time duration between a last command of the set of one or more commands and one or both of the first set of one or more reference signals and the second set of one or more reference signals.

Aspect 7: The method of any of aspects 4-6, further including: receiving, as an output of a first key derivation function, an intermediate first physical layer security key in accordance with inputting a first metric associated with the first channel measurement into the first key derivation function; and receiving, as an output of a second key derivation function, the first physical layer security key in accordance with inputting the intermediate first physical layer security key into the second key derivation function.

Aspect 8: The method of any of aspects 4-7, further including: receiving, as an output of a first key derivation function, an intermediate second physical layer security key in accordance with inputting a second metric associated with the second channel measurement into the first key derivation function; and receiving, as an output of a second key derivation function, the second physical layer security key in accordance with inputting the intermediate second physical layer security key into the second key derivation function.

Aspect 9: The method of any of aspects 1-8, further including: receiving an indication of a first set of physical layer security keys that secures communication between the source device and the passive wireless device, where a selection of the first physical layer security key from the first set of physical layer security keys is associated with the indication of the first set of physical layer security keys.

Aspect 10: The method of aspect 9, where the selection of the first physical layer security key from the first set of physical layer security keys is associated with an indication of the selection by the source device, a first channel measurement of a first channel between the source device and the passive wireless device, timing information of a set of multiple commands associated with a termination of the communication between the source device and the passive wireless device, or any combination thereof.

Aspect 11: The method of any of aspects 1-10, further including: receiving an indication of a second set of physical layer security keys that secures communication between the passive wireless device and the reader device, where a selection of the second physical layer security key from the second set of physical layer security keys is associated with the indication of the second set of physical layer security keys.

Aspect 12: The method of aspect 11, where the selection of the second physical layer security key from the second set of physical layer security keys is associated with an indication of the selection by the source device or the reader device, a second channel measurement of a second channel between the reader device and the passive wireless device, timing information of a set of multiple commands associated with a termination of the communication between the source device and the passive wireless device, or any combination thereof.

Aspect 13: The method of any of aspects 1-12, where the first physical layer security key and the second physical layer security key are stored at the passive wireless device prior to receiving the first message and transmitting the second message.

Aspect 14: The method of any of aspects 1-13, where the communication between the source device and the passive wireless device is secured in accordance with performing a first operation on the first message and the first physical layer security key, the first operation including one or more of a first modulation operation, a first multiplication operation, or a first logical XOR operation, and where the communication between the reader device and the passive wireless device is secured in accordance with performing a second operation on the second message and the first physical layer security key, the second operation including one or more of a second modulation operation, a second multiplication operation, or a second logical XOR operation.

Aspect 15: The method of any of aspects 1-14, where the first message corresponds to a first radio wave associated with a first set of bits and the second message corresponds to a second radio wave associated with a second set of bits, and the backscattering by the passive wireless device is associated with an amplitude shift keying modulation of the first set of bits with the second set of bits via selective reflection by the passive wireless device.

Aspect 16: A method for wireless communications at a reader device, including: receiving a first message from a source device via a passive wireless device, the passive wireless device associated with a backscattering of the first message; and decrypting the first message in accordance with a physical layer security key that secures communication between the passive wireless device and the reader device.

Aspect 17: The method of aspect 16, further including: receiving an indication of the physical layer security key.

Aspect 18: The method of any of aspects 16-17, further including: transmitting, to the passive wireless device, a set of one or more reference signals, where the physical layer security key is associated with a channel measurement of the set of one or more reference signals.

Aspect 19: The method of aspect 18, further including: receiving, as an output of a key derivation function, the physical layer security key in accordance with inputting a metric associated with the channel measurement into the key derivation function.

Aspect 20: The method of any of aspects 18-19, further including: receiving, as an output of a first key derivation function, an intermediate physical layer security key in accordance with inputting a metric associated with the channel measurement into the first key derivation function; and receiving, as an output of a second key derivation function, the physical layer security key in accordance with inputting the intermediate physical layer security key into the second key derivation function.

Aspect 21: The method of any of aspects 16-20, further including: receiving an indication of a set of physical layer security keys that secures communication between the passive wireless device and the reader device, where a selection of the physical layer security key from the set of physical layer security keys is associated with the indication of the set of physical layer security keys.

Aspect 22: The method of aspect 21, where the selection of the physical layer security key from the set of physical layer security keys is associated with an indication of the selection by the source device to the reader device, a channel measurement of a channel between the reader device and the passive wireless device, timing information of a set of multiple commands associated with a termination of the communication between the source device and the passive wireless device, or any combination thereof.

Aspect 23: The method of any of aspects 16-22, where receiving the first message further includes: receiving the first message in accordance with a second physical layer security key that secures communication between the source device and the reader device.

Aspect 24: The method of aspect 23, further including: receiving an indication of the second physical layer security key.

Aspect 25: The method of any of aspects 16-24, further including: transmitting, to the passive wireless device, a second message in accordance with a second physical layer security key that secures communication between the reader device and the passive wireless device, where the source device and the reader device are a same device, and where the first message is a backscattered version of the second message.

Aspect 26: A method for wireless communications at a source device, including: encrypting a first message in accordance with a physical layer security key that secures communication between the source device and a passive wireless device; and transmitting the first message to a reader device via the passive wireless device, the passive wireless device associated with a backscattering of the first message.

Aspect 27: The method of aspect 26, further including: transmitting, to the passive wireless device, an indication of the physical layer security key.

Aspect 28: The method of any of aspects 26-27, further including: transmitting, to the passive wireless device, a set of multiple commands associated with a termination of the communication between the source device and the passive wireless device; and receiving, as an output of a key derivation function, the physical layer security key in accordance with inputting timing information associated with the set of multiple commands into the key derivation function.

Aspect 29: The method of any of aspects 26-28, further including: transmitting, to the passive wireless device, a set of one or more reference signals, where the physical layer security key is associated with a channel measurement of the set of one or more reference signals.

Aspect 30: The method of aspect 29, further including: receiving, as an output of a key derivation function, the physical layer security key in accordance with inputting a metric associated with the channel measurement into the key derivation function.

Aspect 31: The method of any of aspects 29-30, further including: transmitting, to the passive wireless device, a set of one or more commands associated with a termination of the communication between the source device and the passive wireless device, where a timing of the set of one or more reference signals is associated with the set of one or more commands, where the timing is further associated with a fixed time duration between a last command of the set of one or more commands and the set of one or more reference signals.

Aspect 32: The method of any of aspects 29-31, further including: receiving, as an output of a first key derivation function, an intermediate physical layer security key in accordance with inputting a metric associated with the channel measurement into the first key derivation function; and receiving, as an output of a second key derivation function, the physical layer security key in accordance with inputting the intermediate physical layer security key into the second key derivation function.

Aspect 33: The method of any of aspects 26-32, further including: transmitting, to the passive wireless device, an indication of a set of physical layer security keys that secures communication between the source device and the passive wireless device, where a selection of the physical layer security key from the set of physical layer security keys is associated with the indication of the set of physical layer security keys.

Aspect 34: The method of aspect 33, where the selection of the physical layer security key from the set of physical layer security keys is associated with an indication of the selection by the source device to the passive wireless device, a channel measurement of a channel between the source device and the passive wireless device, timing information of a set of multiple commands associated with a termination of the communication between the source device and the passive wireless device, or any combination thereof.

Aspect 35: The method of any of aspects 26-34, further including: transmitting, to one or both of the passive wireless device and the reader device, an indication of a second physical layer security key that secures communication between the passive wireless device and the reader device.

Aspect 36: The method of any of aspects 26-35, further including: transmitting, to one or both of the passive wireless device and the reader device, an indication of a second set of physical layer security keys that secures communication between the passive wireless device and the reader device, where a selection of a second physical layer security key from the second set of physical layer security keys is associated with the indication of the second set of physical layer security keys.

Aspect 37: The method of aspect 36, where the selection of the second physical layer security key from the second set of physical layer security keys is associated with an indication of the selection by the source device to the passive wireless device, a channel measurement of a channel between the reader device and the passive wireless device, timing information of a set of multiple commands associated with a termination of the communication between the source device and the passive wireless device, or any combination thereof.

Aspect 38: The method of any of aspects 26-37, where transmitting the first message includes: transmitting the first message in accordance with a second physical layer security key that secures communication between the source device and the reader device.

Aspect 39: The method of aspect 38, further including: transmitting, to the reader device, an indication of the second physical layer security key.

Aspect 40: The method of any of aspects 26-39, further including: receiving, from the passive wireless device, a second message in accordance with a second physical layer security key that secures communication between the passive wireless device and the reader device, where the source device and the reader device are a same device, and where the second message is a backscattered version of the first message.

Aspect 41: An apparatus for wireless communications at a passive wireless device, including: an interface configured to: obtain a first message in accordance with a first physical layer (PHY) security key that secures communication between a source device and the passive wireless device; and output a second message via a backscattering of the first message and in accordance with a second PHY security key that secures communication between the passive wireless device and a reader device.

Aspect 42: The apparatus of aspect 41, where the interface is further configured to: obtain, from one or both of the source device and the reader device, an indication of the first PHY security key, the second PHY security key, or a combination thereof.

Aspect 43: The apparatus of any of aspects 41-42, where: the interface is further configured to: obtain a set of multiple commands associated with a termination of the communication between the source device and the passive wireless device; and a processing system is configured to: obtain, as an output of one or more key derivation functions, one or both of the first PHY security key and the second PHY security key in accordance with inputting timing information associated with the set of multiple commands into the one or more key derivation functions.

Aspect 44: The apparatus of any of aspects 41-43, where the interface is further configured to: obtain, from the source device, a first set of one or more reference signals, where the first PHY security key is associated with a first channel measurement of the first set of one or more reference signals; and obtain, from the reader device, a second set of one or more reference signals, where the second PHY security key is associated with a second channel measurement of the second set of one or more reference signals.

Aspect 45: The apparatus of aspect 44, where the apparatus includes a processing system configured to: obtain, as an output of a first key derivation function, the first PHY security key in accordance with inputting a first metric associated with the first channel measurement into the first key derivation function; and obtain, as an output of a second key derivation function, the second PHY security key in accordance with inputting a second metric associated with the second channel measurement into the second key derivation function.

Aspect 46: The apparatus of any of aspects 44-45, where the interface is further configured to: obtain a set of one or more commands associated with a termination of the communication between the source device and the passive wireless device, where a timing of one or both of the first set of one or more reference signals and the second set of one or more reference signals is associated with the set of one or more commands, where the timing is further associated with a fixed time duration between a last command of the set of one or more commands and one or both of the first set of one or more reference signals and the second set of one or more reference signals.

Aspect 47: The apparatus of any of aspects 44-46, where the apparatus includes a processing system configured to: obtain, as an output of a first key derivation function, an intermediate first PHY security key in accordance with inputting a first metric associated with the first channel measurement into the first key derivation function; and obtain, as an output of a second key derivation function, the first PHY security key in accordance with inputting the intermediate first PHY security key into the second key derivation function.

Aspect 48: The apparatus of any of aspects 44-47, where the apparatus includes a processing system configured to: obtain, as an output of a first key derivation function, an intermediate second PHY security key in accordance with inputting a second metric associated with the second channel measurement into the first key derivation function; and obtain, as an output of a second key derivation function, the second PHY security key in accordance with inputting the intermediate second PHY security key into the second key derivation function.

Aspect 49: The apparatus of any of aspects 41-48, where the interface is further configured to: obtain an indication of a first set of PHY security keys that secures communication between the source device and the passive wireless device, where a selection of the first PHY security key from the first set of PHY security keys is associated with the indication of the first set of PHY security keys.

Aspect 50: The apparatus of aspect 49, where the selection of the first PHY security key from the first set of PHY security keys is associated with an indication of the selection by the source device, a first channel measurement of a first channel between the source device and the passive wireless device, timing information of a set of multiple commands associated with a termination of the communication between the source device and the passive wireless device, or any combination thereof.

Aspect 51: The apparatus of any of aspects 41-50, where the interface is further configured to: obtain an indication of a second set of PHY security keys that secures communication between the passive wireless device and the reader device, where a selection of the second PHY security key from the second set of PHY security keys is associated with the indication of the second set of PHY security keys.

Aspect 52: The apparatus of aspect 51, where the selection of the second PHY security key from the second set of PHY security keys is associated with an indication of the selection by the source device or the reader device, a second channel measurement of a second channel between the reader device and the passive wireless device, timing information of a set of multiple commands associated with a termination of the communication between the source device and the passive wireless device, or any combination thereof.

Aspect 53: The apparatus of any of aspects 41-52, where the first PHY security key and the second PHY security key are stored at the passive wireless device prior to receiving the first message and transmitting the second message.

Aspect 54: The apparatus of any of aspects 41-53, where: the communication between the source device and the passive wireless device is secured in accordance with performing a first operation on the first message and the first PHY security key, the first operation including one or more of: a first modulation operation, a first multiplication operation, or a first logical XOR operation; and the communication between the reader device and the passive wireless device is secured in accordance with performing a second operation on the second message and the first PHY security key, the second operation including one or more of: a second modulation operation, a second multiplication operation, or a second logical XOR operation.

Aspect 55: The apparatus of any of aspects 41-54, where: the first message corresponds to a first radio wave associated with a first set of bits and the second message corresponds to a second radio wave associated with a second set of bits; and the backscattering by the passive wireless device is associated with an amplitude shift keying modulation of the first set of bits with the second set of bits via selective reflection by the passive wireless device.

Aspect 56: An apparatus for wireless communications at a reader device, including: an interface configured to: obtain a first message from a source device via a passive wireless device, the passive wireless device associated with a backscattering of the first message; and a processing system configured to: decrypt the first message in accordance with a physical layer (PHY) security key that secures communication between the passive wireless device and the reader device.

Aspect 57: The apparatus of aspect 56, where the interface is further configured to: obtain an indication of the PHY security key.

Aspect 58: The apparatus of any of aspects 56-57, where the interface is further configured to: output, to the passive wireless device, a set of one or more reference signals, where the PHY security key is associated with a channel measurement of the set of one or more reference signals.

Aspect 59: The apparatus of aspect 58, where the processing system is further configured to: obtain, as an output of a key derivation function, the PHY security key in accordance with inputting a metric associated with the channel measurement into the key derivation function.

Aspect 60: The apparatus of any of aspects 58-59, where the processing system is further configured to: obtain, as an output of a first key derivation function, an intermediate PHY security key in accordance with inputting a metric associated with the channel measurement into the first key derivation function; and obtain, as an output of a second key derivation function, the PHY security key in accordance with inputting the intermediate PHY security key into the second key derivation function.

Aspect 61: The apparatus of any of aspects 56-60, where the interface is further configured to: obtain an indication of a set of PHY security keys that secures communication between the passive wireless device and the reader device, where a selection of the PHY security key from the set of PHY security keys is associated with the indication of the set of PHY security keys.

Aspect 62: The apparatus of aspect 61, where the selection of the PHY security key from the set of PHY security keys is associated with an indication of the selection by the source device to the reader device, a channel measurement of a channel between the reader device and the passive wireless device, timing information of a set of multiple commands associated with a termination of the communication between the source device and the passive wireless device, or any combination thereof.

Aspect 63: The apparatus of any of aspects 56-62, where, to obtain the first message, the interface is further configured to: obtain the first message in accordance with a second PHY security key that secures communication between the source device and the reader device.

Aspect 64: The apparatus of aspect 63, where the interface is further configured to: obtain an indication of the second PHY security key.

Aspect 65: The apparatus of any of aspects 56-64, where the interface is further configured to: output, to the passive wireless device, a second message in accordance with a second PHY security key that secures communication between the reader device and the passive wireless device, where the source device and the reader device are a same device, and where the first message is a backscattered version of the second message.

Aspect 66: An apparatus for wireless communications at a source device, including: a processing system configured to: encrypt a first message in accordance with a physical layer (PHY) security key that secures communication between the source device and a passive wireless device; and an interface configured to: output the first message to a reader device via the passive wireless device, the passive wireless device associated with a backscattering of the first message.

Aspect 67: The apparatus of aspect 66, where the interface is further configured to: output, to the passive wireless device, an indication of the PHY security key.

Aspect 68: The apparatus of any of aspects 66-67, where: the interface is further configured to: output, to the passive wireless device, a set of multiple commands associated with a termination of the communication between the source device and the passive wireless device; and the processing system is further configured to: obtain, as an output of a key derivation function, the PHY security key in accordance with inputting timing information associated with the set of multiple commands into the key derivation function.

Aspect 69: The apparatus of any of aspects 66-68, where the interface is further configured to: output, to the passive wireless device, a set of one or more reference signals, where the PHY security key is associated with a channel measurement of the set of one or more reference signals.

Aspect 70: The apparatus of aspect 69, where the processing system is further configured to: obtain, as an output of a key derivation function, the PHY security key in accordance with inputting a metric associated with the channel measurement into the key derivation function.

Aspect 71: The apparatus of any of aspects 69-70, where the interface is further configured to: output, to the passive wireless device, a set of one or more commands associated with a termination of the communication between the source device and the passive wireless device, where a timing of the set of one or more reference signals is associated with the set of one or more commands, where the timing is further associated with a fixed time duration between a last command of the set of one or more commands and the set of one or more reference signals.

Aspect 72: The apparatus of any of aspects 69-71, where the processing system is further configured to: obtain, as an output of a first key derivation function, an intermediate PHY security key in accordance with inputting a metric associated with the channel measurement into the first key derivation function; and obtain, as an output of a second key derivation function, the PHY security key in accordance with inputting the intermediate PHY security key into the second key derivation function.

Aspect 73: The apparatus of any of aspects 66-72, where the interface is further configured to: output, to the passive wireless device, an indication of a set of PHY security keys that secures communication between the source device and the passive wireless device, where a selection of the PHY security key from the set of PHY security keys is associated with the indication of the set of PHY security keys.

Aspect 74: The apparatus of aspect 73, where the selection of the PHY security key from the set of PHY security keys is associated with an indication of the selection by the source device to the passive wireless device, a channel measurement of a channel between the source device and the passive wireless device, timing information of a set of multiple commands associated with a termination of the communication between the source device and the passive wireless device, or any combination thereof.

Aspect 75: The apparatus of any of aspects 66-74, where the interface is further configured to: output, to one or both of the passive wireless device and the reader device, an indication of a second PHY security key that secures communication between the passive wireless device and the reader device.

Aspect 76: The apparatus of any of aspects 66-75, where the interface is further configured to: output, to one or both of the passive wireless device and the reader device, an indication of a second set of PHY security keys that secures communication between the passive wireless device and the reader device, where a selection of a second PHY security key from the second set of PHY security keys is associated with the indication of the second set of PHY security keys.

Aspect 77: The apparatus of aspect 76, where the selection of the second PHY security key from the second set of PHY security keys is associated with an indication of the selection by the source device to the passive wireless device, a channel measurement of a channel between the reader device and the passive wireless device, timing information of a set of multiple commands associated with a termination of the communication between the source device and the passive wireless device, or any combination thereof.

Aspect 78: The apparatus of any of aspects 66-77, where, to output the first message, the interface is further configured to: output the first message in accordance with a second PHY security key that secures communication between the source device and the reader device.

Aspect 79: The apparatus of aspect 78, where the interface is further configured to: output, to the reader device, an indication of the second PHY security key.

Aspect 80: The apparatus of any of aspects 66-79, where the interface is further configured to: obtain, from the passive wireless device, a second message in accordance with a second PHY security key that secures communication between the passive wireless device and the reader device, where the source device and the reader device are a same device, and where the second message is a backscattered version of the first message.

Aspect 81: An apparatus for wireless communications at a passive wireless device, including: means for receiving a first message in accordance with a first physical layer security key that secures communication between a source device and the passive wireless device; and means for transmitting a second message via a backscattering of the first message and in accordance with a second physical layer security key that secures communication between the passive wireless device and a reader device.

Aspect 82: The apparatus of aspect 81, further including: means for receiving, from one or both of the source device and the reader device, an indication of the first physical layer security key, the second physical layer security key, or a combination thereof.

Aspect 83: The apparatus of any of aspects 81-82, further including: means for receiving a set of multiple commands associated with a termination of the communication between the source device and the passive wireless device; and means for receiving, as an output of one or more key derivation functions, one or both of the first physical layer security key and the second physical layer security key in accordance with inputting timing information associated with the set of multiple commands into the one or more key derivation functions.

Aspect 84: The apparatus of any of aspects 81-83, further including: means for receiving, from the source device, a first set of one or more reference signals, where the first physical layer security key is associated with a first channel measurement of the first set of one or more reference signals; and means for receiving, from the reader device, a second set of one or more reference signals, where the second physical layer security key is associated with a second channel measurement of the second set of one or more reference signals.

Aspect 85: The apparatus of aspect 84, further including: means for receiving, as an output of a first key derivation function, the first physical layer security key in accordance with inputting a first metric associated with the first channel measurement into the first key derivation function; and means for receiving, as an output of a second key derivation function, the second physical layer security key in accordance with inputting a second metric associated with the second channel measurement into the second key derivation function.

Aspect 86: The apparatus of any of aspects 84-85, further including: means for receiving a set of one or more commands associated with a termination of the communication between the source device and the passive wireless device, where a timing of one or both of the first set of one or more reference signals and the second set of one or more reference signals is associated with the set of one or more commands, where the timing is further associated with a fixed time duration between a last command of the set of one or more commands and one or both of the first set of one or more reference signals and the second set of one or more reference signals.

Aspect 87: The apparatus of any of aspects 84-86, further including: means for receiving, as an output of a first key derivation function, an intermediate first physical layer security key in accordance with inputting a first metric associated with the first channel measurement into the first key derivation function; and means for receiving, as an output of a second key derivation function, the first physical layer security key in accordance with inputting the intermediate first physical layer security key into the second key derivation function.

Aspect 88: The apparatus of any of aspects 84-87, further including: means for receiving, as an output of a first key derivation function, an intermediate second physical layer security key in accordance with inputting a second metric associated with the second channel measurement into the first key derivation function; and means for receiving, as an output of a second key derivation function, the second physical layer security key in accordance with inputting the intermediate second physical layer security key into the second key derivation function.

Aspect 89: The apparatus of any of aspects 81-88, further including: means for receiving an indication of a first set of physical layer security keys that secures communication between the source device and the passive wireless device, where a selection of the first physical layer security key from the first set of physical layer security keys is associated with the indication of the first set of physical layer security keys.

Aspect 90: The apparatus of aspect 89, where the selection of the first physical layer security key from the first set of physical layer security keys is associated with an indication of the selection by the source device, a first channel measurement of a first channel between the source device and the passive wireless device, timing information of a set of multiple commands associated with a termination of the communication between the source device and the passive wireless device, or any combination thereof.

Aspect 91: The apparatus of any of aspects 81-90, further including: means for receiving an indication of a second set of physical layer security keys that secures communication between the passive wireless device and the reader device, where a selection of the second physical layer security key from the second set of physical layer security keys is associated with the indication of the second set of physical layer security keys.

Aspect 92: The apparatus of aspect 91, where the selection of the second physical layer security key from the second set of physical layer security keys is associated with an indication of the selection by the source device or the reader device, a second channel measurement of a second channel between the reader device and the passive wireless device, timing information of a set of multiple commands associated with a termination of the communication between the source device and the passive wireless device, or any combination thereof.

Aspect 93: The apparatus of any of aspects 81-92, where the first physical layer security key and the second physical layer security key are stored at the passive wireless device prior to receiving the first message and transmitting the second message.

Aspect 94: The apparatus of any of aspects 81-93, where a first modulation operation, a first multiplication operation, or a first logical XOR operation, and where the communication between the reader device and the passive wireless device is secured in accordance with performing a second operation on the second message and the first physical layer security key, the second operation including one or more of a second modulation operation, a second multiplication operation, or a second logical XOR operation.

Aspect 95: The apparatus of any of aspects 81-94, where the first message corresponds to a first radio wave associated with a first set of bits and the second message corresponds to a second radio wave associated with a second set of bits, and the backscattering by the passive wireless device is associated with an amplitude shift keying modulation of the first set of bits with the second set of bits via selective reflection by the passive wireless device.

Aspect 96: An apparatus for wireless communications at a reader device, including: means for receiving a first message from a source device via a passive wireless device, the passive wireless device associated with a backscattering of the first message; and means for decrypting the first message in accordance with a physical layer security key that secures communication between the passive wireless device and the reader device.

Aspect 97: The apparatus of aspect 96, further including: means for receiving an indication of the physical layer security key.

Aspect 98: The apparatus of any of aspects 96-97, further including: means for transmitting, to the passive wireless device, a set of one or more reference signals, where the physical layer security key is associated with a channel measurement of the set of one or more reference signals.

Aspect 99: The apparatus of aspect 98, further including: means for receiving, as an output of a key derivation function, the physical layer security key in accordance with inputting a metric associated with the channel measurement into the key derivation function.

Aspect 100: The apparatus of any of aspects 98-99, further including: means for receiving, as an output of a first key derivation function, an intermediate physical layer security key in accordance with inputting a metric associated with the channel measurement into the first key derivation function; and means for receiving, as an output of a second key derivation function, the physical layer security key in accordance with inputting the intermediate physical layer security key into the second key derivation function.

Aspect 101: The apparatus of any of aspects 96-100, further including: means for receiving an indication of a set of physical layer security keys that secures communication between the passive wireless device and the reader device, where a selection of the physical layer security key from the set of physical layer security keys is associated with the indication of the set of physical layer security keys.

Aspect 102: The apparatus of aspect 101, where the selection of the physical layer security key from the set of physical layer security keys is associated with an indication of the selection by the source device to the reader device, a channel measurement of a channel between the reader device and the passive wireless device, timing information of a set of multiple commands associated with a termination of the communication between the source device and the passive wireless device, or any combination thereof.

Aspect 103: The apparatus of any of aspects 96-102, where the means for receiving the first message further include: means for receiving the first message in accordance with a second physical layer security key that secures communication between the source device and the reader device.

Aspect 104: The apparatus of aspect 103, further including: means for receiving an indication of the second physical layer security key.

Aspect 105: The apparatus of any of aspects 96-104, further including: means for transmitting, to the passive wireless device, a second message in accordance with a second physical layer security key that secures communication between the reader device and the passive wireless device, where the source device and the reader device are a same device, and where the first message is a backscattered version of the second message.

Aspect 106: An apparatus for wireless communications at a source device, including: means for encrypting a first message in accordance with a physical layer security key that secures communication between the source device and a passive wireless device; and means for transmitting the first message to a reader device via the passive wireless device, the passive wireless device associated with a backscattering of the first message.

Aspect 107: The apparatus of aspect 106, further including: means for transmitting, to the passive wireless device, an indication of the physical layer security key.

Aspect 108: The apparatus of any of aspects 106-107, further including: means for transmitting, to the passive wireless device, a set of multiple commands associated with a termination of the communication between the source device and the passive wireless device; and means for receiving, as an output of a key derivation function, the physical layer security key in accordance with inputting timing information associated with the set of multiple commands into the key derivation function.

Aspect 109: The apparatus of any of aspects 106-108, further including: means for transmitting, to the passive wireless device, a set of one or more reference signals, where the physical layer security key is associated with a channel measurement of the set of one or more reference signals.

Aspect 110: The apparatus of aspect 109, further including: means for receiving, as an output of a key derivation function, the physical layer security key in accordance with inputting a metric associated with the channel measurement into the key derivation function.

Aspect 111: The apparatus of any of aspects 109-110, further including: means for transmitting, to the passive wireless device, a set of one or more commands associated with a termination of the communication between the source device and the passive wireless device, where a timing of the set of one or more reference signals is associated with the set of one or more commands, where the timing is further associated with a fixed time duration between a last command of the set of one or more commands and the set of one or more reference signals.

Aspect 112: The apparatus of any of aspects 109-111, further including: means for receiving, as an output of a first key derivation function, an intermediate physical layer security key in accordance with inputting a metric associated with the channel measurement into the first key derivation function; and means for receiving, as an output of a second key derivation function, the physical layer security key in accordance with inputting the intermediate physical layer security key into the second key derivation function.

Aspect 113: The apparatus of any of aspects 106-112, further including: means for transmitting, to the passive wireless device, an indication of a set of physical layer security keys that secures communication between the source device and the passive wireless device, where a selection of the physical layer security key from the set of physical layer security keys is associated with the indication of the set of physical layer security keys.

Aspect 114: The apparatus of aspect 113, where the selection of the physical layer security key from the set of physical layer security keys is associated with an indication of the selection by the source device to the passive wireless device, a channel measurement of a channel between the source device and the passive wireless device, timing information of a set of multiple commands associated with a termination of the communication between the source device and the passive wireless device, or any combination thereof.

Aspect 115: The apparatus of any of aspects 106-114, further including: means for transmitting, to one or both of the passive wireless device and the reader device, an indication of a second physical layer security key that secures communication between the passive wireless device and the reader device.

Aspect 116: The apparatus of any of aspects 106-115, further including: means for transmitting, to one or both of the passive wireless device and the reader device, an indication of a second set of physical layer security keys that secures communication between the passive wireless device and the reader device, where a selection of a second physical layer security key from the second set of physical layer security keys is associated with the indication of the second set of physical layer security keys.

Aspect 117: The apparatus of aspect 116, where the selection of the second physical layer security key from the second set of physical layer security keys is associated with an indication of the selection by the source device to the passive wireless device, a channel measurement of a channel between the reader device and the passive wireless device, timing information of a set of multiple commands associated with a termination of the communication between the source device and the passive wireless device, or any combination thereof.

Aspect 118: The apparatus of any of aspects 106-117, where the means for transmitting the first message include: means for transmitting the first message in accordance with a second physical layer security key that secures communication between the source device and the reader device.

Aspect 119: The apparatus of aspect 118, further including: means for transmitting, to the reader device, an indication of the second physical layer security key.

Aspect 120: The apparatus of any of aspects 106-119, further including: means for receiving, from the passive wireless device, a second message in accordance with a second physical layer security key that secures communication between the passive wireless device and the reader device, where the source device and the reader device are a same device, and where the second message is a backscattered version of the first message.

Aspect 121: A non-transitory computer-readable medium storing code for wireless communications at a passive wireless device, the code including instructions executable by a processor to: receive a first message in accordance with a first physical layer security key that secures communication between a source device and the passive wireless device; and transmit a second message via a backscattering of the first message and in accordance with a second physical layer security key that secures communication between the passive wireless device and a reader device.

Aspect 122: A non-transitory computer-readable medium storing code for wireless communications at a reader device, the code including instructions executable by a processor to: receive a first message from a source device via a passive wireless device, the passive wireless device associated with a backscattering of the first message; and decrypt the first message in accordance with a physical layer security key that secures communication between the passive wireless device and the reader device.

Aspect 123: A non-transitory computer-readable medium storing code for wireless communications at a source device, the code including instructions executable by a processor to: encrypt a first message in accordance with a physical layer security key that secures communication between the source device and a passive wireless device; and transmit the first message to a reader device via the passive wireless device, the passive wireless device associated with a backscattering of the first message.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, and the like. Also, “determining” can include receiving (such as receiving information), accessing (such as accessing data in a memory) and the like. Also, “determining” can include resolving, selecting, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or any processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, such as one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in some combinations and even initially claimed as such, one or more features from a claimed combination can be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some implementations, the actions recited in the claims can be performed in a different order and still achieve desirable results.

What is claimed is:

1. An apparatus for wireless communications at a passive wireless device, comprising:
an interface configured to:
obtain a first message in accordance with a first physical layer (PHY) security key that secures communication between a source device and the passive wireless device; and
output a second message via a backscattering of the first message and in accordance with a second PHY security key that secures communication between the passive wireless device and a reader device.

2. The apparatus of claim 1, wherein the interface is further configured to:
obtain, from one or both of the source device and the reader device, an indication of the first PHY security key, the second PHY security key, or a combination thereof.

3. The apparatus of claim 1, wherein:
the interface is further configured to:
obtain a plurality of commands associated with a termination of the communication between the source device and the passive wireless device; and
a processing system is configured to:
obtain, as an output of one or more key derivation functions, one or both of the first PHY security key and the second PHY security key in accordance with inputting timing information associated with the plurality of commands into the one or more key derivation functions.

4. The apparatus of claim 1, wherein the interface is further configured to:
obtain, from the source device, a first set of one or more reference signals, wherein the first PHY security key is associated with a first channel measurement of the first set of one or more reference signals; and
obtain, from the reader device, a second set of one or more reference signals, wherein the second PHY security key is associated with a second channel measurement of the second set of one or more reference signals.

5. The apparatus of claim 4, wherein the apparatus comprises a processing system configured to:
obtain, as an output of a first key derivation function, the first PHY security key in accordance with inputting a first metric associated with the first channel measurement into the first key derivation function; and
obtain, as an output of a second key derivation function, the second PHY security key in accordance with inputting a second metric associated with the second channel measurement into the second key derivation function.

6. The apparatus of claim 4, wherein the interface is further configured to:
obtain a set of one or more commands associated with a termination of the communication between the source device and the passive wireless device, wherein a timing of one or both of the first set of one or more reference signals and the second set of one or more reference signals is associated with the set of one or more commands, wherein the timing is further associated with a fixed time duration between a last command of the set of one or more commands and one or both of the first set of one or more reference signals and the second set of one or more reference signals.

7. The apparatus of claim 4, wherein the apparatus comprises a processing system configured to:
obtain, as an output of a first key derivation function, an intermediate first PHY security key in accordance with inputting a first metric associated with the first channel measurement into the first key derivation function; and
obtain, as an output of a second key derivation function, the first PHY security key in accordance with inputting the intermediate first PHY security key into the second key derivation function.

8. The apparatus of claim 4, wherein the apparatus comprises a processing system configured to:
obtain, as an output of a first key derivation function, an intermediate second PHY security key in accordance with inputting a second metric associated with the second channel measurement into the first key derivation function; and
obtain, as an output of a second key derivation function, the second PHY security key in accordance with inputting the intermediate second PHY security key into the second key derivation function.

9. The apparatus of claim 1, wherein the interface is further configured to:
obtain an indication of a first set of PHY security keys that secures communication between the source device and the passive wireless device, wherein a selection of the first PHY security key from the first set of PHY security keys is associated with the indication of the first set of PHY security keys.

10. The apparatus of claim 1, wherein the interface is further configured to:
obtain an indication of a second set of PHY security keys that secures communication between the passive wireless device and the reader device, wherein a selection of the second PHY security key from the second set of PHY security keys is associated with the indication of the second set of PHY security keys.

11. The apparatus of claim 1, wherein the first PHY security key and the second PHY security key are stored at the passive wireless device prior to receiving the first message and transmitting the second message.

12. The apparatus of claim 1, wherein:
the communication between the source device and the passive wireless device is secured in accordance with performing a first operation on the first message and the first PHY security key, the first operation including one or more of: a first modulation operation, a first multiplication operation, or a first logical XOR operation; and
the communication between the reader device and the passive wireless device is secured in accordance with performing a second operation on the second message and the first PHY security key, the second operation including one or more of: a second modulation operation, a second multiplication operation, or a second logical XOR operation.

13. The apparatus of claim 1, wherein:
the first message corresponds to a first radio wave associated with a first set of bits and the second message corresponds to a second radio wave associated with a second set of bits; and
the backscattering by the passive wireless device is associated with an amplitude shift keying modulation of the first set of bits with the second set of bits via selective reflection by the passive wireless device.

14. An apparatus for wireless communications at a reader device, comprising:
an interface configured to:
obtain a first message from a source device via a passive wireless device, the passive wireless device associated with a backscattering of the first message; and
a processing system configured to:
decrypt the first message in accordance with a physical layer (PHY) security key that secures communication between the passive wireless device and the reader device.

15. The apparatus of claim 14, wherein the interface is further configured to:
obtain an indication of the PHY security key.

16. The apparatus of claim 14, wherein the interface is further configured to:
output, to the passive wireless device, a set of one or more reference signals, wherein the PHY security key is associated with a channel measurement of the set of one or more reference signals.

17. The apparatus of claim 14, wherein, to obtain the first message, the interface is further configured to:
obtain the first message in accordance with a second PHY security key that secures communication between the source device and the reader device.

18. The apparatus of claim 14, wherein the interface is further configured to:
output, to the passive wireless device, a second message in accordance with a second PHY security key that secures communication between the reader device and the passive wireless device, wherein the source device and the reader device are a same device, and wherein the first message is a backscattered version of the second message.

19. An apparatus for wireless communications at a source device, comprising:
a processing system configured to:
encrypt a first message in accordance with a physical layer (PHY) security key that secures communication between the source device and a passive wireless device; and
an interface configured to:
output the first message to a reader device via the passive wireless device, the passive wireless device associated with a backscattering of the first message.

20. The apparatus of claim 19, wherein the interface is further configured to:
output, to the passive wireless device, an indication of the PHY security key.

21. The apparatus of claim 19, wherein:
the interface is further configured to:
output, to the passive wireless device, a plurality of commands associated with a termination of the communication between the source device and the passive wireless device; and
the processing system is further configured to:
obtain, as an output of a key derivation function, the PHY security key in accordance with inputting timing information associated with the plurality of commands into the key derivation function.

22. The apparatus of claim 19, wherein the interface is further configured to:
output, to the passive wireless device, a set of one or more reference signals, wherein the PHY security key is associated with a channel measurement of the set of one or more reference signals.

23. The apparatus of claim 22, wherein the interface is further configured to:
output, to the passive wireless device, a set of one or more commands associated with a termination of the communication between the source device and the passive wireless device, wherein a timing of the set of one or more reference signals is associated with the set of one or more commands, wherein the timing is further associated with a fixed time duration between a last command of the set of one or more commands and the set of one or more reference signals.

24. The apparatus of claim 19, wherein the interface is further configured to:
output, to one or both of the passive wireless device and the reader device, an indication of a second PHY security key that secures communication between the passive wireless device and the reader device.

25. The apparatus of claim 19, wherein, to output the first message, the interface is further configured to:
output the first message in accordance with a second PHY security key that secures communication between the source device and the reader device.

26. The apparatus of claim 19, wherein the interface is further configured to:
obtain, from the passive wireless device, a second message in accordance with a second PHY security key that secures communication between the passive wireless device and the reader device, wherein the source device and the reader device are a same device, and wherein the second message is a backscattered version of the first message.

27. A method for wireless communications at a passive wireless device, comprising:
receiving a first message in accordance with a first physical layer (PHY) security key that secures communication between a source device and the passive wireless device; and
transmitting a second message via a backscattering of the first message and in accordance with a second PHY security key that secures communication between the passive wireless device and a reader device.

28. The method of claim 27, further comprising:
receiving, from one or both of the source device and the reader device, an indication of the first PHY security key, the second PHY security key, or a combination thereof.

29. The method of claim 27, further comprising:
receiving a plurality of commands associated with a termination of the communication between the source device and the passive wireless device; and
receiving, as an output of one or more key derivation functions, one or both of the first PHY security key and the second PHY security key in accordance with inputting timing information associated with the plurality of commands into the one or more key derivation functions.

30. The method of claim 27, further comprising:
receiving, from the source device, a first set of one or more reference signals, wherein the first PHY security key is associated with a first channel measurement of the first set of one or more reference signals; and
receiving, from the reader device, a second set of one or more reference signals, wherein the second PHY security key is associated with a second channel measurement of the second set of one or more reference signals.
